(19) United States
(12) Patent Application Publication
(10) Pub. No.: US 2025/0122065 A1
(43) Pub. Date: Apr. 17, 2025

(54) LIFT DEVICE WITH ADAPTIVE REACH ENVELOPE BASED ON CHASSIS FOOTPRINT

(71) Applicant: Oshkosh Corporation, Oshkosh, WI (US)

(72) Inventors: Wenton Miller, Oshkosh, WI (US); Shashank Bhatia, Oshkosh, WI (US)

(73) Assignee: Oshkosh Corporation, Oshkosh, WI (US)

(21) Appl. No.: 18/913,245

(22) Filed: Oct. 11, 2024

Related U.S. Application Data
(60) Provisional application No. 63/543,792, filed on Oct. 12, 2023.
(60) Provisional application No. 63/699,489, filed on Sep. 26, 2024.

(51) Int. Cl. B66F 17/00

(52) U.S. Cl. CPC B66F 17/00; B66F 17/003; B66F 17/006

(57) ABSTRACT

A lift vehicle includes a chassis, a lift apparatus, an extendable stabilizing member, a sensor, and a controller. The lift apparatus raises or lowers an implement or platform. The extendable stabilizing member can be driven to extend or retract in a direction outwards from the chassis by an actuator between a stowed position and a deployed position. The extendable stabilizing member engages a ground surface. The sensor measures a position of the extendable stabilizing member. The controller obtains the position of the extendable stabilizing member from the sensor. The controller determines a reach envelope based on the position of the extendable stabilizing member. The reach envelope may be reduced in size responsive to retraction of the extendable stabilizing member. The controller operates the lift apparatus according to a user input and restricts operation of the lift apparatus to a point beyond the reach envelope.

### CROSS-REFERENCE TO RELATED PATENT APPLICATION

This application claims the benefit of and priority to U.S. Provisional Application No. 63/543,792, filed Oct. 12, 2023, and U.S. Provisional Application No. 63/699,489, filed Sep. 26, 2024, the entire disclosures both of which are incorporated by reference herein.

### BACKGROUND

Lift vehicles such as telehandlers, aerial work platforms, and the like, are often used to deliver a payload using a boom or arm. In many circumstances the boom or arm of the lift vehicle must reach to great heights or extend to great lengths from the lift vehicle to deliver the payload to a destination. Extending the boom or arm to a great height or to great length from the lift vehicle may pose a risk that the lift vehicle may become unstable or lack structural integrity in certain circumstances.

### SUMMARY

One embodiment of the present disclosure is a lift vehicle. The lift vehicle includes a chassis, a lift apparatus, a first extendable stabilizing member, a second extendable stabilizing member, and a controller. The lift apparatus is configured to raise or lower an implement or platform. The first extendable stabilizing member is configured to extend and retract from a first side of the chassis. The second extendable stabilizing member is configured to extend and retract from a second side of the chassis. The controller is configured to determine an amount of extension or retraction of the first extendable stabilizing member and the second extendable stabilizing member. The controller is also configured to determine a reach envelope for both the first side and the second side of the chassis based on the amount of extension or retraction. The controller is configured to decrease a size of the reach envelope with respect to reduced amounts of extension or retraction. The controller is also configured to, in response to a user input to operate the lift apparatus, operate the lift apparatus according to the user input and restrict movement of the implement or platform beyond a boundary of the reach envelope.

Another embodiment of the present disclosure is a control system for a lift vehicle. The control system includes a first extendable stabilizing member, a second extendable stabilizing member, and processing circuitry. The first extendable stabilizing member is configured to extend and retract from a first side of the lift vehicle. The second extendable stabilizing member is configured to extend and retract from a second side of the lift vehicle. The processing circuitry is configured to determine an amount of extension or retraction of the first extendable stabilizing member and the second extendable stabilizing member. The processing circuitry is also configured to determine a reach envelope for both the first side and the second side of the chassis based on the amount of extension or retraction. The processing circuitry is configured to decrease a size of the reach envelope with respect to reduced amounts of extension or retraction. The processing circuitry is also configured to, in response to a user input to operate the lift apparatus, operate the lift apparatus according to the user input and restrict movement of the implement or platform beyond a boundary of the reach envelope.

Another embodiment of the present disclosure is a method of restricting operation of a lift device. The method includes obtaining an indication of an amount of extension of a first extendable stabilizing member that protrudes from a first side of the lift device and extension of a second extendable stabilizing member that protrudes from a second side of the lift device. The method also includes determining a reach envelope for both the first side and the second side of the lift device based on the amount of extension or retraction. A size of the reach envelope is decreased with respect to reduced amount of the extension or retraction. The method also includes restricting movement of an implement or a platform of the lift device beyond the reach envelope.

Another embodiment of the present disclosure is a lift vehicle. The lift vehicle includes a chassis, a lift apparatus, a first extendable stabilizing member, a second extendable stabilizing member, and a controller. The lift apparatus is configured to raise or lower an implement or platform. The first extendable stabilizing member is configured to extend and retract from a first side of the chassis. The second extendable stabilizing member is configured to extend and retract from a second side of the chassis. The controller is configured to determine a position of the first extendable stabilizing member and a position of the second extendable stabilizing member. In response to the first extendable stabilizing member being at a fully deployed position and the second extendable stabilizing member being at a partially deployed position or stowed position, the controller is configured to determine a first reach envelope for the first side and a second reach envelope for the second side. The second reach envelope is reduced in size based on the partially deployed position or stowed position of the second extendable stabilizing member. In response to a user input to operate the lift apparatus, the controller is configured to operate the lift apparatus according to the user input and restrict movement of the implement or platform beyond a boundary of the first reach envelope or a boundary of the second reach envelope.

Another embodiment of the present disclosure is a control system for a lift vehicle. The control system includes a first extendable stabilizing member, a second extendable stabilizing member, and processing circuitry. The first extendable stabilizing member is configured to extend and retract from a first side of the lift vehicle. The second extendable stabilizing member is configured to extend and retract from a second side of the lift vehicle. The processing circuitry is configured to determine a position of the first extendable stabilizing member and a position of the second extendable stabilizing member. In response to the first extendable stabilizing member being at a fully deployed position and the second extendable stabilizing member being at a partially deployed position or stowed position, the processing circuitry is configured to determine a first reach envelope for the first side and a second reach envelope for the second side. The second reach envelope is reduced in size based on the partially deployed position or stowed position of the second extendable stabilizing member. In response to a user input to operate a lift apparatus of the lift vehicle, the processing circuitry is configured to operate the lift apparatus according to the user input and restrict movement of an implement or platform beyond a boundary of the first reach envelope or a boundary of the second reach envelope.

Another embodiment of the present disclosure is a method of restricting operation of a lift device. The method includes obtaining an indication of extension of a first extendable stabilizing member that protrudes from a first side of the lift device and extension of a second extendable stabilizing member that protrudes from a second side of the lift device. The method also includes determining, based on the first extendable stabilizing member being fully extended, a full reach envelope for the first side of the lift device. The method also includes determining, based on the second extendable stabilizing member being only partially extended or stowed, a reduced reach envelope for the second side of the lift device. The method also includes restricting operation of the lift device beyond the full reach envelope on the first side and beyond the reduced reach envelope on the second side.

Another embodiment of the present disclosure is a lift vehicle. The lift vehicle includes a chassis, a lift apparatus, an extendable stabilizing member, a sensor, and a controller. The lift apparatus is configured to raise or lower an implement or platform. The extendable stabilizing member is configured to be driven to extend or retract in a direction outwards from the chassis by an actuator between a stowed position and a deployed position. The extendable stabilizing member is configured to engage a ground surface. The sensor is configured to measure a position of the extendable stabilizing member. The controller is configured to obtain the position of the extendable stabilizing member from the sensor. The controller is also configured to determine a reach envelope based on the position of the extendable stabilizing member. The reach envelope is reduced in size responsive to the extendable stabilizing member being retracted. The controller is also configured to obtain a user input to operate the lift apparatus and operate the lift apparatus according to the user input and restrict operation of the lift apparatus to move the implement or platform to a point beyond the reach envelope.

In some embodiments, the extendable stabilizing member is a first extendable stabilizing member and the sensor is a first sensor. The lift vehicle can further include a second extendable stabilizing member configured to be driven to extend or retract in an opposite direction outwards from the chassis by another actuator between a stowed position and a deployed position, and a second sensor configured to measure a position of the second extendable stabilizing member. The controller is configured to determine a first reach envelope for a first side of the lift apparatus based on the position of the first extendable stabilizing member. The first reach envelope is a full capacity reach envelope or a reduced reach envelope. The controller is also configured to determine a second reach envelope for a second side of the lift apparatus based on the position of the second extendable stabilizing member. The second reach envelope is a full capacity reach envelope or a reduced reach envelope. The controller is also configured to operate the lift apparatus according to the user input and restrict operation of the lift apparatus to a point beyond the first reach envelope or the second reach envelope.

In some embodiments, the extendable stabilizing member includes an extendable chassis having a tractive element configured to engage the ground surface. In some embodiments, the reach envelope allows limited movement of the lift apparatus while the extendable stabilizing member is in the stowed position.

In some embodiments, the reach envelope is configured to maintain a tipping moment of the lift vehicle less than a threshold amount at all positions of the lift apparatus within the reach envelope. In some embodiments, the reach envelope is a predetermined envelope selected from a database based on a degree of extension or retraction of the extendable stabilizing member.

In some embodiments, the extendable stabilizing member extends from the chassis and is coupled with a tractive element at an opposite end. In some embodiments, the controller is configured to determine a footprint of the lift vehicle based on the position of the extendable stabilizing member and determine the reach envelope based on the footprint. In some embodiments, the lift apparatus includes a telescoping boom.

Another embodiment of the present disclosure is a control system for a lift vehicle. The control system includes an extendable stabilizing member, a sensor, and processing circuitry. The extendable stabilizing member is configured to be driven to extend or retract in a direction outwards from a chassis of the lift vehicle by an actuator between a stowed position and a deployed position. The extendable stabilizing member is configured to engage a ground surface. The sensor is configured to measure a position of the extendable stabilizing member. The processing circuitry is configured to obtain the position of the extendable stabilizing member from the sensor. The processing circuitry is also configured to determine a reach envelope based on the position of the extendable stabilizing member. The reach envelope is reduced in size responsive to the extendable stabilizing member being retracted. The processing circuitry is also configured to obtain a user input to operate a lift apparatus and operate the lift apparatus according to the user input and restrict operation of the lift apparatus to move an implement or platform to a point beyond the reach envelope.

In some embodiments, the extendable stabilizing member is a first extendable stabilizing member and the sensor is a first sensor. In some embodiments, the lift vehicle further includes a second extendable stabilizing member configured to be driven to extend or retract in an opposite direction outwards from the chassis by another actuator between a stowed position and a deployed position, and a second sensor configured to measure a position of the second extendable stabilizing member. The processing circuitry is configured to determine a first reach envelope for a first side of the lift apparatus based on the position of the first extendable stabilizing member. The first reach envelope is a full capacity reach envelope or a reduced reach envelope. The processing circuitry is also configured to determine a second reach envelope for a second side of the lift apparatus based on the position of the second extendable stabilizing member. The second reach envelope is either a full capacity reach envelope or a reduced reach envelope. The processing circuitry is also configured to operate the lift apparatus according to the user input and restrict operation of the lift apparatus to a point beyond the first reach envelope or the second reach envelope.

In some embodiments, the extendable stabilizing member includes an extendable chassis having a tractive element configured to engage the ground surface. In some embodiments, the reach envelope allows limited movement of the lift apparatus while the extendable stabilizing member is in the stowed position.

In some embodiments, the reach envelope is configured to maintain a tipping moment of the lift vehicle less than a threshold amount at all positions of the lift apparatus within the reach envelope. In some embodiments, the reach envelope is a predetermined envelope selected from a database based on a degree of extension or retraction of the extendable stabilizing member.

In some embodiments, the extendable stabilizing member extends from the chassis and is coupled with a tractive element at an opposite end. In some embodiments, the processing circuitry is configured to determine a footprint of the lift vehicle based on the position of the extendable stabilizing member and determine the reach envelope based on the footprint.

Another embodiment of the present disclosure is a method of restricting operation of a lift device. The method includes obtaining an indication of a degree of extension of an extendable stabilizing member. The method also includes determining, based on the degree of extension, a reach envelope for the lift device. The method also includes restricting operation of the lift device beyond the reach envelope.

In some embodiments, the reach envelope is decreased with respect to decreased extension of the extendable stabilizing member in order to maintain a tipping moment of the lift device below a threshold. In some embodiments, the method includes obtaining a user input including command to operate the lift device beyond the reach envelope, and restricting the operation of the lift device beyond the reach envelope in response to the user input.

The invention is capable of other embodiments and of being carried out in various ways. Alternative exemplary embodiments relate to other features and combinations of features as may be recited herein.

### BRIEF DESCRIPTION OF THE FIGURES

FIG. 1 is a perspective view of a first lift vehicle, according to an exemplary embodiment.

FIG. 2 is a perspective view of a second lift vehicle, according to an exemplary embodiment.

FIG. 3 is a schematic of control system, according to an exemplary embodiment.

FIG. 4 is a schematic of a controller of the control system of FIG. 3, according to an exemplary embodiment.

FIG. 5 is a flow chart of a method of determining an adaptive envelope for a lift vehicle, according to an exemplary embodiment.

FIG. 6 is a flow chart of a method of operating a lift vehicle according to an adaptive envelope system, according to an exemplary embodiment.

FIG. 7 is a flow chart of a method of planning an operation of a lift vehicle having an adaptive envelope system, according to an exemplary embodiment.

FIG. 8 is a flow chart of a method of operating a lift vehicle in a drive mode of an adaptive envelope system, according to an exemplary embodiment.

FIG. 9 is a diagram of a graphical user interface of a lift vehicle having an adaptive envelope system, according to an exemplary embodiment.

FIG. 10 is a side view of a base portion of a lift vehicle including an extendable chassis, according to an exemplary embodiment.

FIG. 11 is a diagram illustrating a reach envelope of the lift vehicle of FIG. 10, according to an exemplary embodiment.

FIG. 12 is a diagram illustrating the reach envelopes of FIG. 11 from a top view, according to an exemplary embodiment.

FIG. 13 is a side view of a base portion of another lift vehicle including an extendable chassis, according to an exemplary embodiment.

FIG. 14 is a diagram illustrating a reduced and full capacity reach envelope of the lift vehicle of FIG. 13, according to an exemplary embodiment.

FIG. 15 is a top view of a chassis of a lift vehicle including extendable chassis members or extendable stabilizing members, according to an exemplary embodiment.

FIG. 16 is a front view of the chassis of the lift vehicle of FIG. 15, according to an exemplary embodiment.

FIG. 17 is a block diagram of an adaptive envelope control system for a lift vehicle including extendable stabilizing members, according to an exemplary embodiment.

FIG. 18 is a flow diagram for operating a lift vehicle according to an adaptive envelope based on a position of extendable stabilizer members or a footprint of a chassis of the lift vehicle, according to an exemplary embodiment.

FIG. 19 is a perspective view of a roto-handler including stabilizers and the control system of FIG. 17, according to some embodiments.

FIG. 20 is a front view of a vehicle including outriggers and the control system of FIG. 17, according to some embodiments.

FIG. 21 is a perspective view of the lift vehicle of FIG. 15 having an X-shaped chassis, according to some embodiments.

FIG. 22 is a schematic illustration of the lift device of FIG. 21 with an axle assembly in a retracted position, according to some embodiments.

FIG. 23 is a schematic illustration of the lift device of FIG. 21 with an axle assembly in an expanded position, according to some embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring to the figures generally, the various exemplary embodiments disclosed herein relate to systems, apparatuses, and methods for an adaptive envelope system for a lift vehicle. The adaptive envelope system may be configured to dynamically determine an operating envelope for a lift vehicle, such as an aerial work platform, telehandler, or other vehicle. The operating envelope may define a set of parameters or conditions by which the lift vehicle may operate, while simultaneously defining a set of parameters or conditions by which the lift vehicle may be prohibited from operating. The operating envelope may, in some embodiments, define a threshold limit or a range for one or more lift vehicle parameters (e.g., the extension of a lift arm) where the one or more lift vehicle parameters are limited to operation below the threshold limit or within the range prescribed by the operating envelope. In some embodiments, the operating envelope may reflect the set of parameters or conditions in which the operation of the lift vehicle is stable, safe, efficient, etc.

The adaptive envelope system may determine the operating envelope based on data collected via various sensors affixed to the lift vehicle (e.g., a load sensor, a tilt sensor, a lift arm length sensor, etc.), operator inputs, or other information about the vehicle (e.g., mechanical limits of lift vehicle components, etc.). Upon determining the operating envelope based on collected data, the adaptive envelope system may be configured to apply or enforce the operating envelope by selectively controlling various functions of the lift vehicle. For example, the adaptive envelope system may selectively control a hydraulic system, primary driver system, or other subsystem of the lift vehicle to prevent the operation of the lift vehicle beyond the limits or bounds imposed by an operating envelope. According to an exemplary embodiment, the adaptive envelope system may be configured to regularly and/or continuously collect data in order to regularly and/or continuously determine an appropriate operating envelope for the lift vehicle. In this way, as circumstances change (e.g., a load on the lift arm changes), the operating envelope may similarly change.

### Lift Device

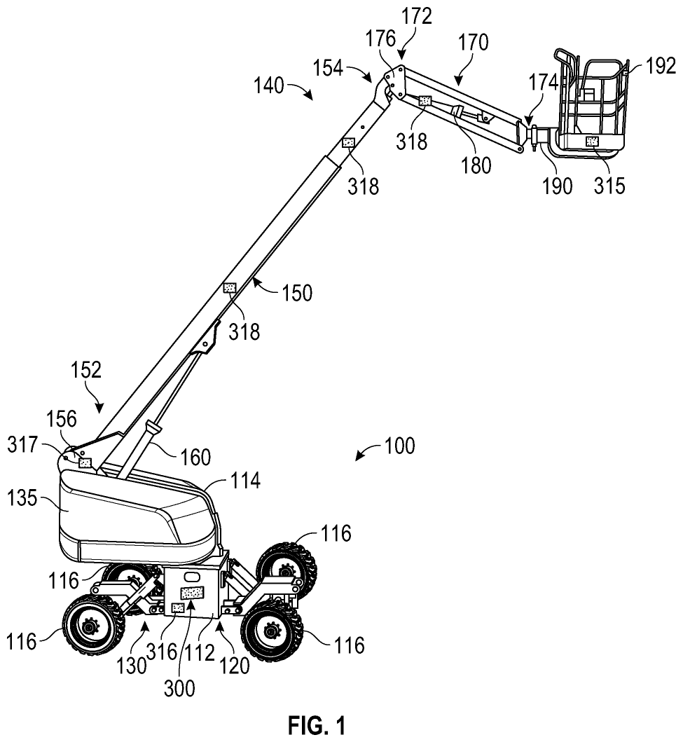

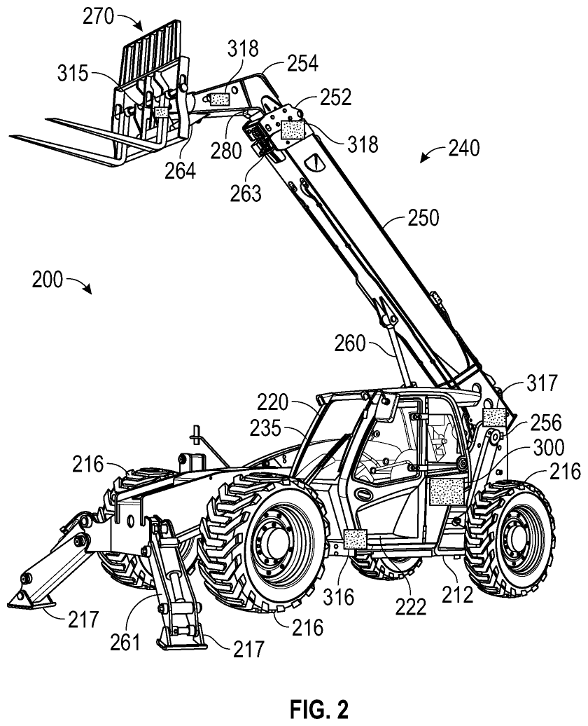

As shown in FIG. 1, a lift vehicle (e.g., an aerial work platform, a boom lift, etc.), shown as lift vehicle 100, includes a chassis, shown as lift base 112. In other embodiments, the lift vehicle 100 is another type of vehicle (e.g., a fire apparatus, a military vehicle, a fire apparatus, an airport rescue fire fighting (“ARFF”) truck, a boom truck, a refuse vehicle, a fork lift, etc.). In particular, the lift vehicle may also be a telehandler, such as the telehandler 200 discussed below with reference to FIG. 2. According to the example shown in FIG. 1, the lift base 112 may support a rotatable structure, shown as turntable 114, and a boom assembly, shown as boom 140. According to an exemplary embodiment, the turntable 114 is rotatable relative to the lift base 112. In one embodiment, the turntable 114 includes a counterweight positioned at a rear of the turntable 114. In other embodiments, the counterweight is otherwise positioned and/or at least a portion of the weight thereof is otherwise distributed throughout the lift vehicle 100 (e.g., on the lift base 112, on a portion of the boom 140, etc.).

As shown in FIG. 1, a first end, shown as front end 120, and an opposing second end, shown as rear end 130, of the lift base 112 is supported by a plurality of tractive elements, shown as tractive elements 116. According to the exemplary embodiment shown in FIG. 1, the tractive elements 116 include wheels. In other embodiments, the tractive elements 116 include track elements or some other tractive element. The lift vehicle 100 may include a plurality of drive actuators that may be positioned to facilitate the independent and selective driving one of the tractive elements 116 to move the lift vehicle 100. In some embodiments, the lift vehicle 100 may only include drive actuators positioned to drive the front tractive elements 116. In another embodiment, the lift vehicle 100 may include drive actuators positioned to drive the front tractive elements 116 and the rear tractive elements 116. In yet other embodiments, the lift vehicle 100 may include drive actuators positioned to drive the rear tractive elements 116. Furthermore, in some embodiments, the lift vehicle 100 may include a plurality of brakes (e.g., one for each tractive element 116, etc.) positioned to independently and selectively restrict rotation of each of the tractive elements 116.

Each of the tractive elements 116 may be powered or unpowered. In some embodiments, the lift vehicle 100 includes a powertrain system including a primary driver 135 (e.g., an engine, an electric motor, etc.). The primary driver 135 may receive fuel (e.g., gasoline, diesel, natural gas, etc.) from a fuel tank and combust the fuel to generate mechanical energy. According to an exemplary embodiment, the primary driver 135 is a compression-ignition internal combustion engine that utilizes diesel fuel. In alternative embodiments, the primary driver 135 is another type of device (e.g., spark-ignition engine, fuel cell, etc.) that is otherwise powered (e.g., with gasoline, compressed natural gas, hydrogen, etc.). Additionally or alternatively, the primary driver 135 include an electric motor that receives electrical energy from one or more energy storage devices (e.g., batteries, capacitors, etc.) or an offboard source of electrical energy (e.g., a power grid, a generator, etc.). In some embodiments, one or more pumps (e.g., a charge pump, an implement pump, and a drive pump) receive the mechanical energy from the primary driver 135 and provide pressurized hydraulic fluid to power the tractive elements 116 and the other hydraulic components of the lift vehicle 100 (e.g., the lift cylinder 160). In some embodiments, the aforementioned charge pump, implement pump, and drive pump provide pressurized hydraulic fluid to drivers or actuators (e.g., hydraulic motors), that are each coupled to one or more of the tractive elements 116 (e.g., in a hydrostatic transmission arrangement). The drive motors each provide mechanical energy to one or more of the tractive elements 116 to propel the lift vehicle 100. In other embodiments, one drive motor drives all of the tractive elements 116. In other embodiments, the primary driver 135 provides mechanical energy to the tractive elements 116 through another type of transmission.

As shown in FIG. 1, the boom 140 includes a first boom section, shown as lower boom 150, and a second boom section, shown as upper boom 170. In other embodiments, the boom 140 includes a different number and/or arrangement of boom sections (e.g., one, three, etc.). According to an exemplary embodiment, the boom 140 is an articulating boom assembly. In one embodiment, the upper boom 170 is shorter in length than the lower boom 150. In other embodiments, the upper boom 170 is longer in length than the lower boom 150. According to another exemplary embodiment, the boom 140 may be telescopic and/or articulating boom assembly, such as the boom assembly 240 discussed with reference to FIG. 2 below. By way of example, the lower boom 150 and/or the upper boom 170 may include a plurality of telescoping boom sections that are configured to extend and retract along a longitudinal centerline thereof to selectively increase and decrease a length of the boom 140.

As shown in FIG. 1, the lower boom 150 has a first end (e.g., a lower end, etc.), shown as base end 152, and an opposing second end, shown as intermediate end 154. The base end 152 of the lower boom 150 is pivotally coupled (e.g., pinned, etc.) to the turntable 114 at a joint, shown as lower boom pivot 156. As shown in FIG. 1, the lift vehicle 100 includes a hydraulic system comprising a plurality of hydraulic actuators 160, 180, etc. The boom 140 includes a first actuator (e.g., pneumatic cylinder, electric actuator, hydraulic cylinder, etc.), shown as lower lift cylinder 160. The lower lift cylinder 160 has a first end coupled to the turntable 114 and an opposing second end coupled to the lower boom 150. According to an exemplary embodiment, the lower lift cylinder 160 is positioned to raise and lower the lower boom 150 relative to the turntable 114 about the lower boom pivot 156 (e.g., to rotate the boom 140 about the boom pivot 156).

As shown in FIG. 1, the upper boom 170 has a first end, shown as intermediate end 172, and an opposing second end, shown as implement end 174. The intermediate end 172 of the upper boom 170 is pivotally coupled (e.g., pinned, etc.) to the intermediate end 154 of the lower boom 150 at a joint, shown as upper boom pivot 176. As shown in FIG. 1, the boom 140 includes an implement, shown as platform assembly 192, coupled to the implement end 174 of the upper boom 170 with an extension arm, shown as jib arm 190. In some embodiments, the jib arm 190 is configured to facilitate pivoting the platform assembly 192 about a lateral axis (e.g., pivot the platform assembly 192 up and down, etc.). In some embodiments, the jib arm 190 is configured to facilitate pivoting the platform assembly 192 about a vertical axis (e.g., pivot the platform assembly 192 left and right, etc.). In some embodiments, the jib arm 190 is configured to facilitate extending and retracting the platform assembly 192 relative to the implement end 174 of the upper boom 170. As shown in FIG. 1, the boom 140 includes a second actuator (e.g., pneumatic cylinder, electric actuator, hydraulic cylinder, etc.), shown as upper lift cylinder 180. According to an exemplary embodiment, the upper lift cylinder 180 is positioned to actuate (e.g., lift, rotate, elevate, etc.) the upper boom 170 and the platform assembly 192 relative to the lower boom 150 about the upper boom pivot 176.

According to an exemplary embodiment, the platform assembly 192 is a structure that is particularly configured to support one or more workers. In some embodiments, the platform assembly 192 includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly 192 includes a control panel to control operation of the lift vehicle 100 (e.g., the turntable 114, the boom 140, etc.) from the platform assembly 192. In other embodiments, the platform assembly 192 includes or is replaced with an accessory and/or tool (e.g., forklift forks, etc.).

Though not described in detail herein, it is understood that the lift vehicle 100 as shown in FIG. 1 could include a leveling system configured to adjust the base 112 in order to ensure that the base 112 and lift vehicle 100 generally remains level relative to a horizontal reference plane. Such a leveling system is described in U.S. Pat. No. 10,858,231, which is incorporated by reference herein in its entirety.

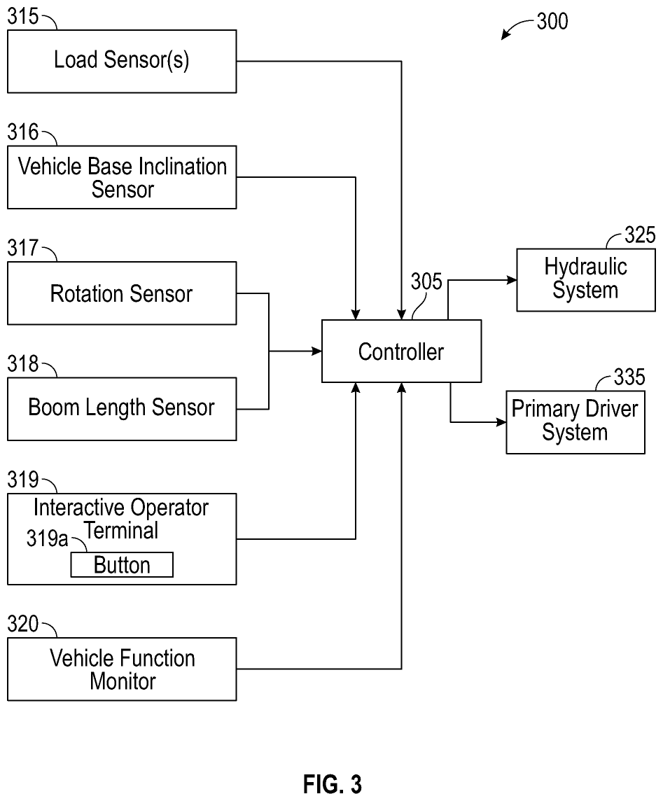

As shown in FIG. 1, the lift vehicle 100 may further include a control system 300 configured to dynamically determine an operating envelope for the lift vehicle 100, monitor one or more sensors associated with the lift vehicle 100, and control the lift vehicle 100, among other operations or processes. As is discussed in detail below with reference to FIGS. 3-8, the control system 300 may determine (e.g., define, establish, create, generate) an operating envelope for the lift vehicle 100 based on one or more parameters, including sensor data, user inputs, etc. For example, as shown in FIG. 1, the control system 300 may be include one or more load sensors 315, one or more vehicle base inclination sensors 316, one or more rotation sensors 317, and/or one or more boom length sensors 318. According to an exemplary embodiment, the control system 300 may facilitate the determination of an operating envelope for the lift vehicle 100 using data monitored or recorded by the load sensor 315, the vehicle base inclination sensor 316, the rotation sensor 317, the boom length sensor 318, or data provided by other sources, as is discussed further below. For example, the control system 300 may determine an operating envelope based on data from the load sensor 315 and the boom length sensor 318 such that the boom 140 can operate within the operating envelope but cannot operate outside of the operating envelope. The control system 300 can determine an operating envelope based on data from one or more sensors to prevent or reduce the incidence of an unstable condition of the lift vehicle 100. The control system 300 can determine an operating envelope based on data from one or more sensors to substantially maintain the structural integrity of the lift vehicle 100.

In one embodiment, the operating envelope determined by the control system 300 may be defined as the space within which boom 140 of the lift vehicle 100 may operate, including, in some embodiments, extension in both the vertical and horizontal directions. In some embodiments, the operating envelope may be a two-dimensional planar region for lift vehicle 100 having no rotatable turntable 114. In other embodiments, specifically embodiments where the lift vehicle 100 does have a rotatable turntable 114, the operating envelope may be the swept volume defined by the reach of the boom 140 over a plurality of lift angles and the rotation of the turntable 114 about the base 112. In this way, the operating envelope may be expressed as a three-dimensional volume.

In various embodiments, the control system 300 may control the lift vehicle 100 in order to allow the lift vehicle 100 to operate within (and up to) one or more boundaries defined by the operating envelope. The control system 300 may positively control the lift vehicle 100 (e.g., allowing certain functions or operator commands to proceed) or may negatively control the lift vehicle 100 (e.g., by prohibiting certain functions or operator commands) based on an operating envelope. For example, the control system 300 may allow the boom 140 of the lift vehicle 100 to extend up to the boundary of the operating envelope. In another example, the control system 300 may allow the lift vehicle 100 to move (e.g., by operating the tractive elements 116 to drive the lift vehicle 100), provided the boom 140 is within the operating envelope.

### Telehandler

According to the exemplary embodiment shown in FIG. 2, a vehicle or lift device, shown as telehandler 200, includes a chassis, shown as frame 212. The frame 212 supports an enclosure, shown as cabin 220, that is configured to house an operator of the telehandler 200. The telehandler 200 is supported by a plurality of tractive elements 216 that are rotatably coupled to the frame 212. One or more of the tractive elements 216 are powered to facilitate motion of the telehandler 200. A manipulator or lift assembly, shown as boom assembly 240, is pivotally coupled to the telehandler 200 near a rear end of the frame 212. The telehandler 200 is configured such that the operator controls the tractive elements 216 and the boom assembly 240 from within the cabin 220 using a plurality of operator controls (not shown) to manipulate (e.g., move, carry, lift, transfer, etc.) a payload (e.g., pallets, building materials, earth, grains, etc.).

Although the vehicle shown and described herein is a telehandler 200, in other embodiments, the systems and methods described herein (e.g., the control system 300) may be utilized with another type of vehicle. By way of example, the vehicle may be the aerial work platform like the lift vehicle 100 of FIG. 1, a scissor lift, a vertical lift, a boom lift, or another type of lift vehicle.

In some embodiments, the boom assembly 240 is approximately centered on a longitudinal centerline that extends along a length of the frame 212. Such a placement may facilitate an even weight distribution between the left and the right sides of the telehandler 200. The cabin 220 is laterally offset from the longitudinal centerline and the boom assembly 240. The cabin 220 includes a door 222 configured to facilitate selective access into the cabin 220. The door 222 may be located on the lateral side of the cabin 220 opposite the boom assembly 240.

The telehandler 200 may include a plurality of tractive elements 216. Each of the tractive elements 216 may be powered or unpowered. In some embodiments, the telehandler 200 includes a powertrain system including a primary driver 235 (e.g., an engine, an electric motor, etc.). The primary driver 235 may receive fuel (e.g., gasoline, diesel, natural gas, etc.) from a fuel tank and combust the fuel to generate mechanical energy. According to an exemplary embodiment, the primary driver 235 is a compression-ignition internal combustion engine that utilizes diesel fuel. In alternative embodiments, the primary driver 235 is another type of device (e.g., spark-ignition engine, fuel cell, etc.) that is otherwise powered (e.g., with gasoline, compressed natural gas, hydrogen, etc.). Additionally or alternatively, the primary driver 235 include an electric motor that receives electrical energy from one or more energy storage devices (e.g., batteries, capacitors, etc.) or an offboard source of electrical energy (e.g., a power grid, a generator, etc.). In some embodiments, one or more pumps (e.g., a charge pump, an implement pump, and a drive pump) receive the mechanical energy from the primary driver 235 and provide pressurized hydraulic fluid to power the tractive elements 116 and the other hydraulic components of the telehandler 200 (e.g., the lift cylinders 260). In some embodiments, the aforementioned charge pump, implement pump, and drive pump provide pressurized hydraulic fluid to drivers or actuators (e.g., hydraulic motors), that are each coupled to one or more of the tractive elements 216 (e.g., in a hydrostatic transmission arrangement). The drive motors each provide mechanical energy to one or more of the tractive elements 216 to propel the telehandler 200. In other embodiments, one drive motor drives all of the tractive elements 216. In other embodiments, the primary driver 235 provides mechanical energy to the tractive elements 216 through another type of transmission.

Still referring to FIG. 2, the tractive elements 216 are coupled to the frame 212 by lateral support members, such as axles. Specifically, the two frontmost tractive elements 216 are coupled to opposite ends of a first axle, and the two rearmost tractive elements 216 are coupled to opposite ends of a rear axle. The axles are pivotally coupled to the frame 212 and configured to pivot relative to the frame 212 about a longitudinal axis, facilitating roll of the frame 212 about the longitudinal axis. The telehandler 200 further includes a pair of leveling actuators configured as linear hydraulic actuators (e.g., hydraulic cylinders), where the leveling actuators that are each coupled to one of the axles and to the frame 212. The levelling actuators may be configured to extend and retract to rotate the frame 212 relative to the axles, causing the frame 212 to roll, which can in turn affect the angular orientation of the chassis relative to some reference plane. For example, the leveling actuators may be actuated to level the frame 212 on sloped or uneven surfaces. In some embodiments, the leveling actuators may be independently controlled to permit independent control of the front and rear of the frame 212.

In some embodiments, one or more of the tractive elements 216 are configured to be steered to control or direct the movement of the telehandler 200. For example, the telehandler 200 may include a pair of steering actuators (e.g., hydraulic cylinders). More specifically, the telehandler 200 may include a front steering cylinder that may be coupled to a frontmost axle and coupled (e.g., by one or more tie rods) to each of the frontmost tractive elements 216. The front steering cylinder is configured to translate laterally to rotate each of the front wheels about a corresponding vertical axis. When the front steering cylinder moves in a first direction from a center position, for example, the tractive elements 216 turn to steer the telehandler 200 to the left. When the front steering cylinder moves in a second direction opposite the first direction from the center position, the tractive elements 216 turn to steer the telehandler 200 to the right. Likewise, the telehandler 200 may include a rear steering cylinder that may be coupled to a rearmost axle and coupled to each of the rearmost tractive elements 216. The rear steering cylinder may then provide steering control of the rearmost tractive elements 116. In some embodiments, the telehandler 200 may include a front steering cylinder and a rear steering cylinder that are independently controlled. In some embodiments, the telehandler 200 may utilize a skidsteer arrangement (e.g., the tractive elements 216 on the left side of the telehandler 200 move at a different speed and/or in a different direction than the tractive elements 116 on the right side of the telehandler 200 to steer the telehandler 200).

Referring again to FIG. 2, the boom assembly 240 is a telescoping assembly having a series of nested members including a proximal or base section 250, an intermediate or middle section 252, and a distal or fly section 254. The base section 250 is pivotally coupled to the rear end of the frame 212 such that the boom assembly 240 is pivotable about a lateral axis. More particularly, the boom assembly 240 may be coupled to the telehandler 200 at a boom pivot 256. The middle section 252 is received within the base section 250 and extends outward beyond the base section 250. The fly section 254 is received within the middle section 252 and extends outward beyond the middle section 252. In other embodiments, the middle section 252 is omitted, and the fly section 254 is received directly within the base section 250. In yet other embodiments, the boom assembly 240 includes multiple middle sections 252. The base section 250, the middle section 252, and the fly section 254 are each slidably coupled to one another to facilitate varying an overall length of the boom assembly 240. Specifically, the middle section 252 is slidably coupled to the base section 250, and the fly section 254 is slidably coupled to the middle section 252.

The boom assembly 240 further includes a tool, manipulator, interface or implement, shown as implement 270, coupled to a distal end of the fly section 254. The implement 270 may be pivotally coupled to the fly section 254 such that the implement 270 is pivotable relative to the fly section 254 about a lateral axis. The implement 270 may facilitate interfacing the boom assembly 240 with materials (e.g., wood, hay, building materials, etc.) or one or more operators or users. The implement 270 may be powered (e.g., by pressurized hydraulic fluid from a hydraulic system) or unpowered. As shown in FIG. 2, the implement 270 is a fork mechanism comprising a plurality of tines which are configured to lift a palletized payload. For example, the implement 270 can be a pair of forks (e.g., two fork tines), such as forks structured to lift a pallet. In other embodiments, the implement 270 is a bucket, a material handling arm, a boom, a hook, a hopper, a sweeper, a grapple, or another type of implement configured to handle material. In other embodiments, the implement 270 is a work platform configured to support one or more operators. In some embodiments, the implement 270 is selectively coupled to the fly section 254 such that the implement 270 is interchangeable with other implements. By way of example, the forks shown in FIG. 2 may be removed and exchanged with a bucket or work platform.

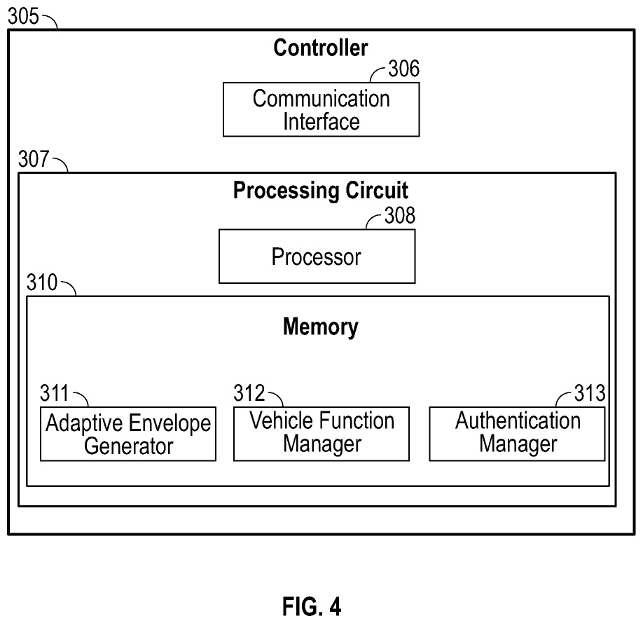

Still referring to FIG. 2, the boom assembly 240 is articulated by a series of actuators. In some embodiments, the actuators are powered by pressurized hydraulic fluid (e.g., from a hydraulic system, such as the hydraulic system 325 shown in FIG. 3, as controlled by the controller 305, as also shown in FIGS. 3 and 4). The telehandler 200 includes a first linear actuator (e.g., hydraulic cylinder), shown as lift cylinder 260. A lower end the lift cylinder 260 is coupled to the frame 212, and an upper end of the lift cylinder 260 is coupled to the base section 250. In one embodiment, two lift cylinders 260 may be utilized, with a lift cylinder positioned on an opposing side of the boom assembly 240 to facilitate an even distribution of the load of the boom assembly 240. When the lift cylinder 260 extends, the boom assembly 240 is raised (e.g., the angle between an axis of the boom assembly 240 and the frame 212 of the telehandler 200 increases as the boom assembly 240 rotates about the pivot 256). When the lift cylinders 260 retract, the boom assembly 240 is lowered (e.g., the angle between an axis of the boom assembly 240 and the frame 212 of the telehandler 200 decreases).

The telehandler 200 further includes a second linear actuator (e.g., a hydraulic cylinder), namely a telescoping cylinder, to control the boom assembly 240. A proximal end of the telescoping cylinder is coupled to the base section 250, and a distal end of the telescoping cylinder is coupled to the middle section 252. When the telescoping cylinder is extended, the middle section 252 moves longitudinally outward from the base section 250. When the telescoping cylinder is retracted, the middle section 252 moves back into the base section 250. A tensile member (e.g., a rope, a strap, a chain, etc.), shown as cable 263, includes a first end coupled to the base section 250 and a second end that is coupled to the fly section 254. The cable 263 extends from the base section 250, around a distal end of the middle section 252, and attaches to a portion of the fly section 254 that is received within the middle section 252. Accordingly, when the telescoping cylinder extends, moving the middle section 252 outward, the middle section 252 applies a tensile force to the cable 263, which draws the fly section 254 out of the middle section 252. A similar cable arrangement may be utilized to retract the fly section 254 into the middle section 252 when the middle section 252 retracts into the base section 250. Accordingly, the extension of the telescoping cylinder both (a) extends the middle section 252 relative to the base section 250 and (b) extends the fly section 254 relative to the middle section 252. Similarly, the retraction of the telescoping cylinder both (a) retracts the middle section 252 relative to the base section 250 and (b) retracts the fly section 254 relative to the middle section 252.

The telehandler 200 further includes a third linear actuator (e.g., a hydraulic cylinder), shown as tilt cylinder 264. A proximal end of the tilt cylinder 264 is coupled to the fly section 254, and a distal end of the tilt cylinder 264 is coupled to the implement 270. When the tilt cylinder 264 is retracted, the implement 270 rotates in a first direction (e.g., downward) relative to the fly section 254. When the tilt cylinder 264 is extended, the implement 270 rotates in a second direction (e.g., upward) relative to the fly section 254.

The telehandler 200 may further include two or more stabilizers, shown as stabilizers 217. The stabilizers 217 may be positioned proximate to the two frontmost tractive elements 216 and coupled to the frame 212. Each of the stabilizers 217 may further be configured to rotate relative to the frame 212 such that the stabilizers 217 may be rotated in a first direction (e.g., downwards) so that the stabilizers 217 come into contact with a ground surface, as is shown in FIG. 2. When rotated into a downward position, the stabilizers 217 may be configured to lift a front end of the telehandler 200 off of a ground surface such that the two frontmost tractive elements 216 are not in contact with a ground surface, according to an exemplary embodiment. In another embodiment, the two frontmost tractive elements 216 may remain in contact with a ground surface while the stabilizers 217 are engaged with the ground surface. The stabilizers 217 may further be configured to rotate in a second direction (e.g., upwards) so that the stabilizers 217 may disengage the ground surface or may be lifted off of the ground surface. The stabilizers may be actuated via a linear hydraulic actuator (e.g., hydraulic cylinder), shown as stabilizer cylinder 261. According to one embodiment, the stabilizer cylinder 261 may be configured to rotate the stabilizer 217 upwards and downwards as described above as the stabilizer cylinder is retracted or extended, respectfully.

As shown in FIG. 2, the telehandler 200 may further include a control system 300 configured to dynamically determine an operating envelope for the telehandler 200, monitor one or more sensors associated with the telehandler 200, or control the telehandler 200. As is discussed in detail below with reference to FIGS. 3-8, the control system 300 may determine an operating envelope for the telehandler 200 based on one or more parameters, including sensor data, user inputs, etc. For example, as shown in FIG. 2, the control system 300 may be include one or more load sensors 315, one or more vehicle base inclination sensors 316, one or more rotation sensors 317, and/or one or more boom length sensors 318. According to an exemplary embodiment, the control system 300 may facilitate the determination of an operating envelope for the telehandler 200 using data monitored or recorded by the load sensor 315, the vehicle base inclination sensor 316, the rotation sensor 317, the boom length sensor 318, or data provided by other sources, as is discussed further below. For example, the control system 300 may determine an operating envelope based on data from the load sensor 315 and the boom length sensor 318 such that the boom assembly 240 can operate within the operating envelope but cannot operate outside of the operating envelope. The control system 300 can determine an operating envelope based on data from one or more sensors to prevent or reduce the incidence of an unstable condition of the telehandler 200. The control system 300 can determine an operating envelope based on data from one or more sensors to substantially maintain the structural integrity of the telehandler 200.

In one embodiment, the operating envelope determined by the control system 300 may be defined as the space within which the boom assembly 240 of the telehandler 200 may operate, including, in some embodiments, both extension in vertical and horizontal directions. In some embodiments, the operating envelope may be a planar region for telehandler 200. In other embodiments, the operating envelope may be expressed as a three-dimensional volume.

In various embodiments, the control system 300 may control the telehandler 200 in order to allow the telehandler 200 to operate within (and up to) one or more boundaries defined by the operating envelope. The control system 300 may positively control the telehandler 200 (e.g., allowing certain functions or operator commands to proceed) or may negatively control the telehandler 200 (e.g., by prohibiting certain functions or operator commands) based on an operating envelope. For example, the control system 300 may allow the boom assembly 240 of the telehandler 200 to extend up to the boundary of the operating envelope. In another example, the control system 300 may allow the telehandler 200 to move (e.g., by operating the tractive elements 216 to drive the telehandler 200), provided the boom assembly 240 is within the operating envelope.

### Adaptive Envelope System

Referring now to FIG. 3, a schematic of an adaptive envelope system, shown as control system 300, may be configured to selectively and dynamically determine an operating envelope for a lift vehicle, such as the lift vehicle 100 or telehandler 200 described above. The control system 300 may be implemented and used by a lift vehicle, such as the lift vehicle 100 or the telehandler 200. The control system 300 may include a controller 305 that is coupled to one or more of the load sensor 315, the vehicle base inclination sensor 316, the rotation sensor 317, the boom length sensor 318, an interactive operator terminal 319, a vehicle function monitor 320, a hydraulic system 325, and primary driver system 335, and other lift vehicle subsystems (e.g., communication system, etc.). According to an exemplary embodiment, the controller 305 is communicably coupled to the one or more of the load sensor 315, the vehicle base inclination sensor 316, the rotation sensor 317, the boom length sensor 318, an interactive operator terminal 319, a vehicle function monitor 320, a hydraulic system 325, and primary driver system 335 such that the controller 305 may receive data transmissions from and transmit data to each of the load sensor 315, the vehicle base inclination sensor 316, the rotation sensor 317, the boom length sensor 318, an interactive operator terminal 319, a vehicle function monitor 320, a hydraulic system 325, and primary driver system 335. The controller 305 may be further configured to manipulate, interrogate, and analyze received data. In another embodiment, the controller 305 may be configured to poll or prompt v the load sensor 315, the vehicle base inclination sensor 316, the rotation sensor 317, the boom length sensor 318, and other data sources (e.g., terminal 319 or monitor 320) for data. Furthermore, the controller 305 may be configured to transmit instructions or commands to the hydraulic system 325 and/or the primary driver system 335 in order to control functions of the hydraulic system 325 and/or the primary driver system 335. In some embodiments, the commands transmitted by the controller 305 may be based upon the received data. According to an exemplary embodiment, the controller 305 may utilize received data to determine an operating envelope for a lift vehicle.

As noted above, the controller 305 may be coupled to a plurality of sensors, namely one or more load sensors 315, one or more vehicle base inclination sensors 316, one or more rotation sensors 317, and one or more boom length sensors 318. The controller 305 may be communicably coupled to the one or more load sensors 315, one or more vehicle base inclination sensor 316, and one or more rotation sensors 317 so that the controller 305 may receive data from the load sensor 315, the vehicle base inclination sensor 316, the rotation sensor 317, or the boom length sensor 318 as is discussed in detail below with reference to FIG. 4, among others. More specifically, the controller 305 may be configured to receive a continuous data stream or periodic data transmissions from the load sensor 315, the vehicle base inclination sensor 316, the rotation sensor 317, or the boom length sensor 318.

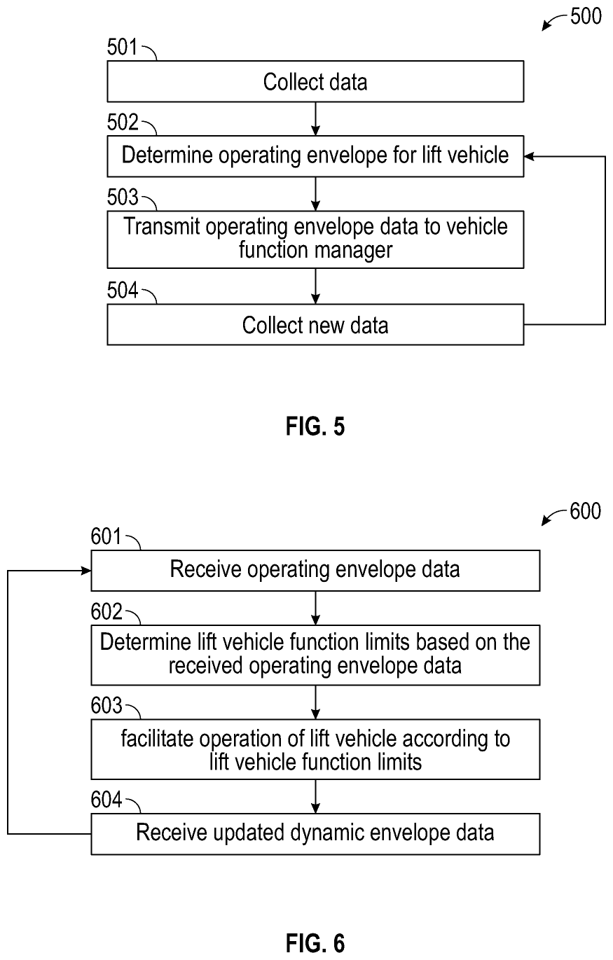

The load sensor 315 may be configured to determine a load applied to a lift arm (e.g., boom 140 or boom assembly 240), namely a load applied to the platform 192 or implement 270 of the lift vehicle 100 or telehandler 200, respectively. The load sensor 315 may be a strain gauge, a load cell, etc. configured to measure the load at a particular point on the lift arm. The load sensor 315 may be communicably coupled to the controller 305, as indicated above. The vehicle base inclination sensor 316 may be configured to determine an angular orientation of a chassis (e.g., the base 112 or the frame 212) of the lift vehicle (e.g., the lift vehicle 100, the telehandler 200, or some other vehicle) relative to some reference plane. According to an exemplary embodiment, the vehicle base inclination sensor 316 may be configured to determine the angular orientation of the lift vehicle chassis relative to a horizontal reference plane, as is shown in further detail with reference to FIG. 5. The vehicle base inclination sensor 316 may be an inclinometer or similar tilt sensor device. The vehicle base inclination sensor 316 may be configured to determine the angular orientation of the lift vehicle chassis with respect to one, two, or more axes (e.g., a pitch axis and a roll axis). Furthermore, one or more vehicle base inclination sensors 316 may be disposed about the chassis of the lift vehicle. Each of the one or more vehicle base inclination sensors 316 may be communicably coupled to the controller 305 and or to other devices within the control system 300.

The one or more rotation sensors 317 may be configured to measure the angular orientation of the lift arm (e.g., the boom 140, the boom assembly 240, or some other lift arm) relative to the vehicle (e.g., relative to the vehicle chassis). More particularly, the rotation sensor 317 may be measure the rotation of the lift arm about the lower boom pivot 156 or boom pivot 256. The rotation sensor 317 may be further configured to transmit data regarding the rotation of the lift arm to the controller 305, where the data regarding the rotation of lift arm indicates whether the lift arm is in a lowered position, a raised position, or some other position therebetween. The rotation sensor 317 may be magnetic angle sensors, an optical rotation sensor, a rotary potentiometer, an encoder device, or some other similar device.

The boom length sensor 318 may be positioned at one or more positions along the lift arm (e.g., the boom 140, the boom assembly 240, or some other lift arm) to measure the extended length of the lift arm. According to an exemplary embodiment, three or more boom length sensors 318 may be implemented to measure the position of each lift arm segment (e.g., segment 252, segment 254, and segment 256). Depending on the lift arm embodiment, namely whether the lift arm is a telescoping boom, an articulating arm, or some combination thereof, the boom length sensors 318 may be configured to determine the extended length of the lift arm by measuring linear movement (e.g., linear extension/retraction of the boom assembly 240) or rotational movement (e.g., rotation of a first arm section of an articulating arm relative to a second arm section, where the relative rotation indicates an unfolding or folding of the various lift arm sections). The boom length sensor 318 may thus be a rotation sensor similar to the rotation sensors 317 described above, or the boom length sensor 318 may be a linear position sensor, such as a cable-based length sensor, a laser-based length sensor, or some other device. In another embodiment, the length of a telescoping boom, such as the boom assembly 240, may be determined indirectly by measuring the hydraulic pressure in a telescoping cylinder, as discussed above. Like the load sensor 315, the vehicle base inclination sensor 316, and the rotation sensor 317, the boom length sensors 318 may be communicably coupled to the controller 305 and capable of transmitting data to the controller 305.

The control system 300 may further include an interactive operator terminal 319. The interactive operator terminal 319 may be configured to receive user input from an operator related to lift vehicle functions (e.g., raising/lowering of the boom 140, extension/retraction of the boom assembly 240, etc.). The user input may control the one or more functions of the lift vehicle (e.g., the lift vehicle 100, the telehandler 200, or some other vehicle) during operation of the lift vehicle or the user input may serve to plan the operation of various lift vehicle functions (e.g., planning to extend the boom assembly 240), as is described further below. The user input may also control other functions of the lift vehicle, such as functions related to driving the lift vehicle (e.g., operating tractive elements 116 or tractive elements 216) or switching an operating mode of the lift vehicle (e.g., a “lift mode” or a “drive mode”). In one embodiment, the interactive operator terminal 319 may be a touchscreen display capable of receiving input from an input member (e.g., finger, stylus, etc.). In another embodiment, the interactive operator terminal 319 may include one or more buttons, switches, dials, or similar devices configured receive user input. In yet another embodiment, the interactive operator terminal 319 may include some combination of a display device (e.g., touchscreen) and buttons, switches, etc. The interactive operator terminal 319 may be, for example, mounted within the cabin 220 of the telehandler 200, mounted to a railing of the platform assembly 192, may be transportable (e.g., a tablet computing device, etc.), or otherwise configured.

As depicted in FIG. 3, among others, the interactive operator terminal 319 can include a button 319a. The button 319a, when pressed, toggled, or selected, may be configured to cause the control system 300 to generate an adaptive operating envelope and/or enforce the operating envelope, as is discussed in greater detail below with reference to FIG. 4. For example, the adaptive envelope system described herein may not operate until a user input is provided to the interactive operator terminal 319 via the button 319a. The button 319a may be a push button, a two-way switch, a selectable icon on a graphical user interface, a keyed switch, or some other similar device. In some embodiments, the button 319a may include or be associated with an illuminating element (e.g., an LED light) that illuminates to provide an indication of a status of the adaptive envelope system. The button 319a may illuminate when the adaptive envelope system determines that “extra reach” is available to an operator such that the operator may extend the lift arm (e.g., boom 140, boom assembly 240, or some other lift apparatus) of the lift vehicle further than is allowed according to the operating envelope. For example, the button 319a can illuminate or otherwise indicate that additional reach is available based on updated data from one or more of the load sensor 315, the vehicle base inclination sensor 316, the rotation sensor 317, the boom length sensor 318, where the updated data indicates that a condition has changed (e.g., an inclination of the vehicle) such that an operating envelope based on the updated data allows greater reach than a currently-enforced operating envelope based on earlier data. The button 319a or some other feature or icon of the interactive operator terminal 319 can indicate that a new operating envelope can be established based on updated data from one or more of the load sensor 315, the vehicle base inclination sensor 316, the rotation sensor 317, and the boom length sensor 318. For example, selection of the button 319a can establish a new operating envelope based on updated data from the load sensor 315, the vehicle base inclination sensor 316, the rotation sensor 317, or the boom length sensor 318. The new operating envelope can supersede (e.g., replace) a previously established or currently enforced operating envelope. For example, the control system 300 may operate to allow the extra reach of the lift vehicle (e.g., the boom 140 or the boom assembly 240) only when a user input related to the button 319a is received.

In addition, the control system 300 may include one or more monitoring devices configured to provide instantaneous (e.g., measured, recorded, captured) or predetermined data pertaining to various lift vehicle functions, shown as vehicle function monitor 320. The vehicle function monitor 320 may provide data related to the various functions of the lift vehicle (e.g., the lift vehicle 100, the telehandler 200, or some other vehicle), such as the status of the lift arm (e.g., the boom 140, the boom assembly 240, or some other lift arm), the implement (e.g., the platform assembly 192, the implement 270), the tractive elements (e.g., the tractive elements 116, the tractive elements 216, or some other tractive element), the stabilizers (e.g., the stabilizers 217), or otherwise. More specifically, the vehicle function monitor 320 may be configured to indicate to the controller 305 what it is the lift vehicle is doing by measuring data from other sensors besides the load sensor 315, the vehicle base inclination sensor 316, the rotation sensor 317, and the boom length sensor 318 as described above. Moreover, the vehicle function monitor 320 may provide data to the controller 305 regarding an operating mode of the lift vehicle, such as a “lift mode” or a “drive mode,” where the mode could be automatically determined by the controller 305, selected by a user via the interactive operator terminal 319, or otherwise determined.

In addition, the vehicle function monitor 320 may include a database of information about the lift vehicle (e.g., the lift vehicle 100, the telehandler 200, or some other vehicle), including information regarding safe operating conditions for the lift vehicle, mechanical limits of various lift vehicle components (e.g., mechanical limits of the lift arm), or other performance metrics. For example, the vehicle function monitor 320 may store data related to desired operating of the lift vehicle while in a “lift mode,” such as an optimal reserve stability moment, a desired RPM of an engine, etc. In such embodiments, the vehicle function monitor 320 may include a memory device storing known information pertaining to the lift vehicle or some similar device. In another embodiment, the vehicle function monitor 320 may include a remotely located database configured to wirelessly transmit information pertaining to the lift vehicle to the control system via the controller 305 and communication interface 306, as is shown in FIG. 4. In various other embodiments, the vehicle function monitor 320 may store information related to operating modes of the lift vehicle. For example, the vehicle function monitor 320 may store one or more rules, commands, etc. related to the operating modes of the vehicle and may transmit that information to the controller 305 when the lift vehicle is in a particular mode. The vehicle function monitor 320 may thus provide information about the lift vehicle not captured by the load sensor 315, the vehicle base inclination sensor 316, the rotation sensor 317, or the boom length sensor 318 as may be necessary to control the lift vehicle, particularly in the context of dynamically determining an operating envelope for the lift vehicle.

As shown in FIG. 3, the controller 305 may be communicably coupled to the hydraulic system 325, to the primary driver system 335, or to some other vehicle subsystem (e.g., communications system, etc.). The hydraulic system 325 may include the various hydraulic actuators discussed above (e.g., the lift cylinder 160, the lift cylinder 260), according to an exemplary embodiment. The primary driver system 335 may include the primary driver (e.g., the primary driver 135, the primary driver 235) of the lift vehicle (e.g., the lift vehicle 100, the telehandler 200, or some other vehicle) and any related components, according to an exemplary embodiment. The controller 305 may be configured to transmit commands to the hydraulic system 325 and the primary driver system 335 in order to control said systems 325 and 335 for the purpose of establishing and maintaining an operating envelope for the vehicle. For example, the controller 305 may be configured to issue a command that controls the operation of the hydraulic system 325 such that the lift arm (e.g., the boom 140, the boom assembly 240, or some other lift arm) of the lift vehicle is permitted to extend to a certain maximum extension length in some circumstances (e.g., when the lift vehicle is lifting a heavy payload) that different than a maximum extension length in other circumstances (e.g., when the vehicle is not lifting a heavy payload), thereby establishing a dynamic, context-dependent maximum boom length. To achieve this, the controller 305 may thus be configured to restrict the flow of hydraulic fluid to various hydraulic actuators (e.g., telescoping cylinders, the lift cylinder 160, the lift cylinder 260, etc.) to limit the actuation of said actuators, according to an exemplary embodiment.

In another embodiment, the controller 305 may be configured to similarly control the operation of the primary driver system 335 in order to achieve a dynamic, context-dependent maximum boom length. For example, the controller 305 may be configured to issue a command to the primary driver system 335 to limit the RPM of an engine, which further limits the rate at which the hydraulic system 325 may generate hydraulic pressure. In various embodiments, therefore, the controller 305 may be configured to control the operation of the hydraulic system 325 and the primary driver system 335 to establish and enforce a dynamic operating envelope for the lift vehicle (e.g., the lift vehicle 100, the telehandler 200, or some other vehicle). In yet other embodiments, the controller 305 may be configured to issue various other commands to control other lift vehicle functions (e.g., control movement of the tractive elements 116, control movement of the tractive elements 216, control engine RPM, etc.). For example, the controller 305 may be configured to prohibit operation of the tractive elements 116 or the tractive elements 216 until the lift vehicle (e.g., the boom 140 or the boom assembly 240) is within a certain operating envelope.

Referring now to FIG. 4, a schematic of the controller 305 is shown. The controller 305 may include a communication interface 306 and a processing circuit 307. The processing circuit 307 may include a processor 308 and a memory 310. The memory 310 may include an adaptive envelope generator 311, a vehicle function manager 312, and an authentication manager 313. In other embodiments the adaptive envelope generator 311, the vehicle function manager 312, and authentication manager 313 may comprise application-specific circuitry that is not stored in the memory 310. In yet another embodiment, the adaptive envelope generator 311, the vehicle function manager 312, and authentication manager 313 may comprise computer-executable code that is stored in one or more memory devices located remotely from the lift vehicle (e.g., the lift vehicle 100, the telehandler 200, or some other vehicle). According to an exemplary embodiment, and as discussed above, the controller 305 is configured to control and monitor (e.g., by receiving data from sensors) various functions of the lift vehicle such as the operation of the hydraulic system 325, operation of the primary driver system 335, or some other components to control the operation of the lift arm (e.g., the boom 140, the boom assembly 240).

In various embodiments, the controller 305 is communicably coupled to the load sensor 315, the vehicle base inclination sensor 316, the rotation sensor 317, the boom length sensor 318, the interactive operator terminal 319, vehicle function monitor 320, hydraulic system 325, and primary driver system 335. The data recorded by the load sensor 315, the vehicle base inclination sensor 316, the rotation sensor 317, or the boom length sensor 318 may be saved and analyzed. Likewise, data transmitted from the interactive operator terminal 319 to the controller 305 and data from the vehicle function monitor 320 transmitted to the controller 305 may be saved and analyzed. The controller 305 is also communicably coupled to the hydraulic system 325 and primary driver system 335 such that the controller 305 may control the hydraulic system 325 (e.g., by sending operating parameters to the various hydraulic cylinders) and/or the primary driver system 335 (e.g., by sending operating parameters to an engine).

As indicated above, the controller 305 includes a network interface circuit, shown as communication interface 306 configured to enable the controller 305 to exchange information over a network. The communication interface 306 can include program logic that facilitates connection of the controller 305 to the network (e.g., a cellular network, Wi-Fi, Bluetooth, radio, etc.). The communication interface 306 can support communications between the controller 305 and other systems, such as a remote monitoring computing system. For example, the communication interface 306 can include a cellular modem, a Bluetooth transceiver, a radio-frequency identification (RFID) transceiver, and a near-field communication (NFC) transmitter. In some embodiments, the communication interface 306 includes the hardware and machine-readable media sufficient to support communication over multiple channels of data communication.

The communication interface 306 may also facilitate the transmission of data and commands between the controller 305 and various other systems or devices (e.g., the load sensor 315, the vehicle base inclination sensor 316, the rotation sensor 317, the boom length sensor 318, the interactive operator terminal 319, the vehicle function monitor 320, hydraulic system 325, the primary driver system 335, or some other system or device). In such embodiments, the communication interface 306 may communicate with other systems or devices via an internal communications network, such as a controller area network (CAN bus) or another vehicle electronic communications protocol. Put another way, each of the load sensor 315, the vehicle base inclination sensor 316, the rotation sensor 317, the boom length sensor 318, the interactive operator terminal 319, the vehicle function monitor 320, the hydraulic system 325, and the primary driver system 335 may be communicably coupled to the controller 305 via the communication interface 306 using a CAN bus network or similar protocol.

The controller 305 is shown to include a processing circuit 307, which further includes a processor 308 and a memory 310. The processor 308 may be coupled to the memory 310. The processor 308 may be a general purpose or specific purpose processor, an application specific integrated circuit (ASIC), one or more field programmable gate arrays (FPGAs), a group of processing components, or other suitable processing components. The processor 308 is configured to execute computer code or instructions stored in the memory 310 or received from other computer readable media (e.g., CDROM, network storage, a remote server, etc.).

The memory 310 may include one or more devices (e.g., memory units, memory devices, storage devices, etc.) for storing data and/or computer code for completing and/or facilitating the various processes described in the present disclosure. The memory 310 may include random access memory (RAM), read-only memory (ROM), hard drive storage, temporary storage, non-volatile memory, flash memory, optical memory, or any other suitable memory for storing software objects and/or computer instructions. The memory 310 may include database components, object code components, script components, or any other type of information structure for supporting the various activities and information structures described in the present disclosure. The memory 310 may be communicably connected to the processor 308 via processing circuit 307 and may include computer code for executing (e.g., by the processor 308) one or more of the processes described herein.

An adaptive envelope generator 311 is configured to collect data collected by the load sensor 315, the vehicle base inclination sensor 316, the rotation sensor 317, the boom length sensor 318, the interactive operator terminal 319, and/or the vehicle function monitor 320 and to determine an appropriate operating envelope for the lift vehicle (e.g., the lift vehicle 100, the telehandler 200, or some other vehicle), according to an exemplary embodiment. The adaptive envelope generator 311 may analyze collected data pertaining to the lift vehicle (e.g., the lift vehicle 100, the telehandler 200, or some other device), whether that data is representative of a current lift vehicle circumstance (e.g., a load on the implement 270 from the load sensor 315 or a lift arm length measurement from the boom length sensor 318) or a known vehicle parameter (e.g., a threshold load value at which the lift vehicle becomes unstable or lacks structural integrity at a given boom length provided by the vehicle function monitor 320) in order to determine an operating envelope for the lift vehicle. As noted above, the operating envelope for the lift vehicle may be a two or three-dimensional space establishing an outer bound for the operation of the lift arm (e.g., the boom 140 or the boom assembly 240) of the lift vehicle, according to an exemplary embodiment. The operating envelope may thus establish a set of parameters in which the lift arm may operate (e.g., positions of the lift arm within the operating envelope) and a set of parameters in which the lift arm may be prevented from operating (e.g., positions of the lift arm outside of the operating envelope).

In an exemplary embodiment, the operating envelope determined by the adaptive envelope generator 311 may define a maximum or minimum extension of the lift arm (e.g., the boom 140, the boom assembly 240, or some other lift arm), a maximum or minimum angle of rotation of the lift arm relative to the lift vehicle chassis, or any of a variety of other parameters of the lift arm, for example. In one embodiment, the maximum extension of the lift arm as defined by the operating envelope may vary with the angle of rotation of the lift arm relative to the chassis such that a maximum extension of the lift arm may be a first length at a first angle of rotation relative to the chassis and a second length at a second angle of rotation relative to the chassis. In another embodiment, the maximum extension of the lift arm may vary based on another parameter. Therefore, the operating envelope, which is defined by collected data (e.g., data from the load sensor 315, the vehicle base inclination sensor 316, the rotation sensor 317, the boom length sensor 318, input from the interactive operator terminal 319, or data from the vehicle function monitor 320), may establish the parameters within which the lift arm of the vehicle is permitted to operate.

As indicated above, the operating envelope may be determined based on collected data that is analyzed by the adaptive envelope generator 311. In one example, the adaptive envelope generator 311 may analyze data from the load sensor 315 and the vehicle base inclination sensor 316 in order to define an operating envelope. In such an example, a lift vehicle lifting a first load (e.g., a load of 500 lbs.) measured by the load sensor 315 while the lift vehicle (e.g., the lift vehicle 100, the telehandler 200, or some other vehicle) is at a first angular orientation of the chassis relative to a horizontal reference plane (e.g., 2° from horizontal) measured by the vehicle base inclination sensor 316 may be subject to a first operating envelope. The first operating envelope is therefore determined by the first load and the first angular orientation. If the load or angular orientation change, whether in real time or otherwise, a second operating envelope may be defined by the new load and/or new angular orientation. For example, if the lift vehicle delivers the payload such that the vehicle is now lifting a lesser second load while the lift vehicle remains at the first angular orientation relative to the horizontal reference plane, a second operating envelope may be defined by the adaptive envelope generator 311 according to the second load and the first angular orientation. In such a circumstance, the second operating envelope may permit greater extension of the lift arm (e.g., the boom 140, the boom assembly 240, or some other lift arm) than the first operating envelope because the lesser second load produces a lesser risk of creating an unstable condition for the lift vehicle. Likewise, if the angular orientation of the lift vehicle changes to a more aggressive second angular orientation relative to a horizontal reference plane, a third operating envelope may be defined by the adaptive envelope generator 311 according to the second load and the second angular orientation, for example. In such a circumstance, the third operating envelope may limit the maximum extension of the lift arm to a greater degree than the second operating envelope.

In yet another example, the adaptive envelope generator 311 may determine an operating envelope for the lift vehicle (e.g., the lift vehicle 100, the telehandler 200, or some other vehicle) based on a load lifted by the lift vehicle as measured by the load sensor 315 and the length of the lift arm (e.g., the boom 140, the boom assembly 240, or some other lift arm) as measured by the boom length sensor 318. More specifically, for a given load and a given boom length, the adaptive envelope generator 311 may determine a maximum extension of the lift arm or a maximum or minimum lift arm angle for the left vehicle. Thus, based on the extension of the lift arm, the adaptive envelope generator 311 may determine an appropriate operating envelope. Of course, the above-mentioned examples are merely illustrative. The adaptive envelope generator 311 is configured to dynamically determine an operating envelope for the lift vehicle based on a wide variety of collected data, where the operating envelope determined by the adaptive envelope generator 311 may dynamically change as the collected data changes (e.g., as the lift vehicle changes from one state to another).

Furthermore, the adaptive envelope generator 311 may determine multiple operating envelopes for a single set of lift vehicle conditions, where one of the multiple operating envelopes corresponds to an operating mode of the lift vehicle (e.g., the lift vehicle 100, the telehandler 200, or some other vehicle). Put another way, a lift vehicle in a particular circumstance (e.g., a particular load, a particular chassis incline, etc.) might be subject to multiple operating envelopes, such as an operating envelope for use when the lift vehicle is in a lift mode, work mode, active mode, etc. and an operating envelope for use if and when the lift vehicle transitions into a drive mode (e.g., a mode in which the tractive elements 116, 216 are in use). According to one embodiment, the operating envelope associated with a drive mode may further limit the extension of the lift arm (e.g., the boom 140, the boom assembly 240, or some other lift arm) when the lift vehicle is in a drive mode to ensure that sudden or rapid changes to the angular orientation of the lift vehicle chassis do not create an unsafe or unstable condition. For example, a lift vehicle may be driving along terrain with an uneven surface or with periodic inclines or declines, which may cause the angular orientation of the lift vehicle chassis to change suddenly as the lift vehicle drives along the terrain. In such a circumstance, a drive mode operating envelope may be imposed that limits the operation of the lift arm so that no unsafe or unstable condition is created by the rugged terrain. This drive mode operating envelope may be based upon the load applied to the lift arm, according to one embodiment. In another embodiment, the drive mode operating envelope may not be based on a load applied to the lift arm (but may instead by entirely independent of the load).

Based on the operating envelope determined by the adaptive envelope generator 311, the vehicle function manager 312 may be configured to control or modify various lift vehicle functions in accordance with the determined operating envelope. For example, the vehicle function manager 312 may generate a command or control signal that, when transmitted by the controller 305 to the hydraulic system 325, controls or modifies the operation of one or more hydraulic cylinders (e.g., the lift cylinder 160, the lift cylinder 260, a telescoping cylinder, etc.) according to the operating envelope. According to an exemplary embodiment, the vehicle function manager 312 may be configured to limit the maximum extension of the lift arm (e.g., the boom 140, the boom assembly 240, or some other lift arm) based on the operating envelope. In another embodiment, the vehicle function manager 312 may be configured to dynamically limit the maximum extension of the lift arm based on the rotation of the lift arm relative to the vehicle chassis such that the maximum extension of the lift arm at a first angle of rotation is different (e.g., more or less) than the maximum extension of the lift arm at a second angle of rotation. In yet another embodiment, the vehicle function manager 312 may be configured to limit the engine speed, movement of the tractive elements (e.g., the tractive elements 116 or the tractive elements 216), limit the movement of stabilizers (e.g., the stabilizers 217), etc. based on the operating envelope determined by the adaptive envelope generator 311.

As shown in FIG. 3, the controller 305 may be communicably coupled to both the hydraulic system 325 and the primary driver system 335, according to an exemplary embodiment. Because the controller 305 is coupled to the hydraulic system 325 and the primary driver system 335, the vehicle function manager 312 is thus communicably coupled to the hydraulic system 325 and the primary driver system 335. Accordingly, the vehicle function manager 312 may be configured to transmit a signal, command, data, etc. to one or both of the hydraulic system 325 and the primary driver system 335 for the purpose of affecting the functioning of the lift vehicle (e.g., the lift vehicle 100, the telehandler 200, or some other vehicle), such as by applying or enforcing the operating envelope as determined by the adaptive envelope generator 311.

The vehicle function manager 312 may be further configured to control or modify various functions of the lift vehicle (e.g., the lift vehicle 100, the telehandler 200, or some other vehicle) to operate the lift vehicle in a drive mode. As noted above, the drive mode may be associated with the movement of the lift vehicle along the ground (e.g., movement of the tractive elements 116 or the tractive elements 216) from a first location to a second location. For example, the lift vehicle may drive along a ground surface (e.g., gravel, dirt, cement, etc.) to deliver a payload, according to an exemplary embodiment. When operating in the drive mode, the operation of the lift arm (e.g., the boom 140, the boom assembly 240, or some other lift arm) may be restricted or limited according to a drive mode operating envelope, as described above. However, in some instances, an operator will be operating outside of the drive mode (e.g., in a lift mode, etc.) and will seek to drive the lift vehicle or will command the lift vehicle to drive. In this circumstance, the lift arm may be beyond the boundary of the drive mode operating envelope when the operator commands the lift vehicle to drive, which may result in an unsafe or unstable condition as described above. For this reason, the vehicle function manager 312 may, in response to receiving a command to drive the vehicle, cause the lift arm to retract to a position that is within the drive mode operating envelope before allowing the lift vehicle to drive, according to an exemplary embodiment. For example, the vehicle function manager 312 may prevent the lift vehicle from driving until an operator retracts the lift arm to a position within the drive mode operating envelope, whereupon the vehicle function manager 312 may allow the operator to drive the vehicle. Furthermore, the vehicle function manager 312 may limit the speed of the lift vehicle as it drives in order to ensure the lift vehicle does not operate in an unsafe or unstable manner.

The authentication manager 313 may be configured to authenticate an operator or user before the adaptive envelope generator 311 and vehicle function manager 312 operate to alter the operating envelope for a vehicle. As indicated above the adaptive envelope generator 311 and vehicle function manager 312 may operate independently and in concert to create and enforce an operating envelope for a lift vehicle that is greater (e.g., provides greater reach, extension, mobility for the lift arm of a lift vehicle) than an operating envelope for a lift vehicle that lacks the adaptive envelope system of the present disclosure. Put another way, the operating envelope generated by the adaptive envelope generator 311 and enforced by the vehicle function manager 312 may allow a movement of a lift arm (e.g., the boom 140, the boom assembly 240, or some other lift arm) that would otherwise be prohibited on other lift vehicles for perceived safety risks or other reasons. To ensure that this functionality is not used by operators or users with insufficient training, credentials, or skill, the authentication manager 313 may be configured to allow operation of the adaptive envelope system only by authorized or authenticated users, thereby prohibiting operation of the adaptive envelope system by unauthorized or unauthenticated users.

According to one embodiment, the authentication manager 313 may be configured to identify an authentication credential of an operator currently operating the lift vehicle. For example, the communication interface 306 of the controller 305 may receive a near-field wireless transmission (e.g., RFID communication, Bluetooth transmission, etc.) from a mobile device (e.g., identification badge, cellular phone, key fob, etc.) of an operator. The wireless transmission may be include an identifier that identifies the operator. The authentication manager 313 may then be configured to compare the received identifier with a database, table, list, etc. of known authenticated operators. If the received identifier matches a known identifier, the user is deemed to be authenticated and the authentication manager 313 may allow the operator to perform various functions described herein as associated with the adaptive envelope system. In another embodiment, the authentication manager 313 may determine a level of authentication for a user, where certain functions associated with the adaptive envelope system are available only to those operators having a sufficient authentication level, while other functions are available to those having a lower authentication level or no authentication level, for example.

In another embodiment, the operator may be prompted to provide an input to the interactive operator terminal 319, where the input is used by the authentication manager 313 top authenticate the operator. For example, the authentication manager 313 may cause the interactive operator terminal 319 to display a prompt for a user credential, such as an employee ID number, a cell phone number, a license number, a username and password, etc. The authentication manager 313 may then authentication the operator based on the received user credential, such as by comparing the received user credential with a database of known user credentials. The authentication manager 313 may prompt the operator to provide the user credential when the operator begins to operate the lift vehicle or when the operator attempts to perform a certain operation (e.g., move the lift arm of the lift vehicle beyond a particular safety limit in accordance with the adaptive envelope system).

In yet another embodiment, the button 319a of the interactive operator terminal 319 may trigger the authentication manager 313 to authenticate the operator. More specifically, if an operator selects the button 319a of the interactive operator terminal 319 to use the adaptive envelope system, the authentication manager 313 may first perform an authentication to ensure that the operator is authorized to use the adaptive envelope system or to perform a particular movement using the adaptive envelope system.

In various embodiments, the authentication manager 313 may compare received authentication data (e.g., a wireless transmission from an operator's mobile device or input by an operator via the interactive operator terminal 319) with known authentication data. The known authentication data may be stored locally on a storage device of the lift vehicle (e.g., the memory 310) or remotely (e.g., a remote database, central service, etc.). In some embodiments, the authentication manager 313 will perform the comparison of authentication data. In other embodiments, the authentication may occur by a remote authentication service or by some third party, where the authentication manager 313 may receive from an indication of authentication from the remote authentication service or third-party.

According to an exemplary embodiment, the adaptive envelope generator 311, the vehicle function manager 312, and the authentication manager 313 may be configured to provide a visual or audible indication to an operator of the machine as to a status of the adaptive envelope system via the interactive operator terminal 319 or the button 319a. For example, the button 319a may include an illuminating element (e.g., colored LED light) that illuminates when the adaptive envelope generator 311 generates an operating envelope that permits additional reach of the lift arm (e.g., the boom 140, the boom assembly 240, or some other lift arm) beyond what may be ordinarily permitted without the use of the adaptive envelope system). More specifically, the button 319a may illuminate in one color or predefined pattern (e.g., pulsing, flashing, etc.) when additional reach of the lift arm is available via the adaptive envelope system. If the user selects the button 319a to activate the adaptive envelope system, the button 319a may illuminate a second color or predefined pattern to indicate that the adaptive envelope system is activated. Furthermore, the button 319a may illuminate in a third color or predefined pattern when the adaptive envelope system is in use (e.g., when the lift arm is extended beyond the allowable limits of a lift vehicle not having the adaptive envelope system).

In another embodiment, the button 319a may illuminate when the vehicle function manager 312 is operating to control a vehicle function. For example, the button 319a may illuminate to indicate that the lift arm (e.g., the boom 140, the boom assembly 240, or some other lift arm) has reached a limit defined by the operating envelope such that the vehicle function manager 312 is restricting or prohibiting further extension to enforce the boundary of the operating envelope as described above. In yet another embodiment, the button 319a, when pressed, may provide some indication to the user that additional reach of the lift arm is available according to the operating envelope generated by the adaptive envelope generator 311. In still another embodiment, the button 319a may indicate that the operator is or is not authenticated to use the adaptive envelope system. For example, if the operator is not authenticated by the authentication manager 313, the button 319a may be deactivated such that the button 319a may not be selected by an operator to use the adaptive envelope system. In another example, the button 319a may illuminate a certain color to indicate that the operator is not authenticated to use the adaptive envelope system.

Accordingly, the button 319a may be operatively coupled to the adaptive envelope generator 311, the vehicle function manager 312, and the authentication manager 313. In various embodiments, one or more functions of the adaptive envelope generator 311, vehicle function manager 312, and the authentication manager 313 may be available to an operator only if the button 319a is pressed, switched, toggled, etc. In some embodiments, certain functions may only be available to an operator while the button 319a remains pressed, switched, etc., such that when an operator releases the button 319a, those certain functions become unavailable to the operator. In other embodiments, an input selecting the button 319a may provide an operator with temporary access to certain functionality of the adaptive envelope generator 311, vehicle function manager 312, and authentication manager 313 for a predetermined amount of time.

Referring now to FIG. 5, a flow chart of a method 500 for determining an adaptive envelope for a lift vehicle (e.g., the lift vehicle 100, the telehandler 200, or some other vehicle) is shown. The method 500 may be performed by the adaptive envelope generator 311 of the controller 305, as shown and described above with reference to FIGS. 3 and 4, according to an exemplary embodiment.

At process 501, the adaptive envelope generator 311 may collect data from one or more sensors, operator interfaces, or other sources. In particular, the adaptive envelope generator 311 may receive data from a variety of sensors, such as the load sensor 315, the vehicle base inclination sensor 316, the rotation sensor 317, the boom length sensor 318, or some other sensor. The adaptive envelope generator 311 may also collect data from other sources, such as the interactive operator terminal 319 or the vehicle function monitor 320. The adaptive envelope generator 311 may be communicably coupled the various data sources via CAN bus communication protocol or some other means, as described above with reference to FIGS. 3 and 4. The data collected at process 501 may indicate or represent the current status or condition of the lift vehicle (e.g., the lift vehicle 100, the telehandler 200, or some other vehicle). For example, the data collected at process 501 may include data indicating a load on a lift arm (e.g., the boom 140, the boom assembly 240, or some other lift arm) of the lift vehicle, an angular orientation of the lift vehicle chassis relative to a reference plane, a length of the lift arm, or some other parameter, as described above.

At process 502, the adaptive envelope generator 311 may determine an operating envelope based on the data collected at process 501. More particularly, the adaptive envelope generator 311 may determine the bounds of an operating envelope within which the lift arm (e.g., the boom 140, the boom assembly 240, or some other lift arm) of the lift vehicle (e.g., the lift vehicle 100, the telehandler 200, or some other vehicle) may operate without posing a risk of unstable condition or inadequate structural integrity, where the bounds of the operating envelope are dependent upon the data collected at process 501. For example, if the data collected at process 501 includes data from the load sensor 315 indicating that the lift vehicle is or will be lifting a heavy load, the adaptive envelope generator 311 may determine an operating envelope comprising an appropriate maximum extension of the lift arm in order to ensure the lift vehicle operates only within safe or stable conditions. Likewise, if the data collected at process 501 indicates that the lift arm is extended to a great degree, the adaptive envelope generator 311 may determine an operating envelope comprising appropriate limitations on the rotation of the lift arm relative to the vehicle chassis to ensure that the lift vehicle operates only within safe or stable conditions. As described above, the adaptive envelope generator 311 may determine whether a particular operation (e.g., extension of the lift arm beyond a certain point) would be unsafe based on known vehicle parameters or physical properties, such as the structural integrity of various vehicle components, the propensity for a lift vehicle to tip or become when subject to a certain moment arm, etc.

At process 503, the adaptive envelope generator 311 may transmit operating envelope data to the vehicle function manager 312 of the controller 305 after the operating envelope has been determined at process 502. The adaptive envelope generator 311 may transmit the operating envelope data to the vehicle function manager 312 so that the vehicle function manager 312 may command or control various functions of the lift vehicle (e.g., the lift vehicle 100, the telehandler 200, or some other vehicle) according to the determined operating envelope.

At process 504, the adaptive envelope generator 311 may collect new data, similar to the data collected at process 501. More specifically, because the adaptive envelope generator 311 may be configured to dynamically (e.g., instantaneously, continuously, in real time, etc.) alter the operating envelope of the lift vehicle as circumstances change, the adaptive envelope generator 311 may be configured to poll the various sensors and data sources (e.g., the load sensor 315, the vehicle base inclination sensor 316, the rotation sensor 317, the boom length sensor 318, the terminal 319, and the monitor 320) for new data on a continuous or regular basis.

As new data is collected at process 504, the method 500 may return to process 502 where the adaptive envelope generator 311 may determine a new operating envelope for the lift vehicle (e.g., the lift vehicle 100, the telehandler 200, or some other vehicle) as circumstances change (e.g., a payload is delivered, the angular orientation of the chassis relative to a reference plane changes, the length of the lift arm is changed, etc.). In this way, the method 500 may be iterative such that the adaptive envelope generator 311 is regularly or continuously collecting data, determining an appropriate operating envelope based on the collected data, and transmitting the operating envelope data to the vehicle function manager 312.

Referring now to FIG. 6, a flow chart of a method 600 of operating a lift vehicle (e.g., the lift vehicle 100, the telehandler 200, or some other vehicle) according to an adaptive envelope system is shown. The method 600 may be performed by the vehicle function manager 312 of the controller 305 as shown in FIGS. 3 and 4, according to an exemplary embodiment.

At process 601, the vehicle function manager 312 may receive operating envelope data. More particularly, the vehicle function manager 312 may receive operating envelope data as determined by the adaptive envelope generator 311 as described above with reference to process 503. According to an exemplary embodiment, the operating envelope data may define a two-dimensional or three-dimensional zone within which the lift vehicle (e.g., the lift vehicle 100, the telehandler 200, or some other vehicle) may operate without posing a safety risk under the present circumstances. For example, the operating envelope data may define, for a plurality of angles of lift arm rotation relative to the vehicle chassis, a maximum extension of the lift arm (e.g., the boom 140, the boom assembly 240, or some other lift arm). In another example, the operating envelope data may define a maximum or minimum primary driver output (e.g., engine RPM, etc.), a position of the stabilizers (e.g., the stabilizers 217), an allowable movement of tractive elements (e.g., the tractive elements 116 or the tractive elements 216), or some other prescription for one or more lift vehicle functions.

At process 602, the vehicle function manager 312 may determine lift vehicle (e.g., the lift vehicle 100, the telehandler 200, or some other vehicle) function limits based on the received operating envelope data. In some embodiments, the operating envelope data may define a two-dimensional or three-dimensional range of permissible operation for the lift arm (e.g., the boom 140, the boom assembly 240, or some other lift arm) of the lift vehicle. Accordingly, it may be necessary for the vehicle function manager 312 to determine how the various functions of the lift vehicle need to be controlled based on the received operating envelope data to enforce or apply the operating envelope in relation to the lift vehicle. For example, the lift arm may be the boom 140 and may have an articulating arm section (e.g., the upper boom 170) and a telescoping arm section (e.g., the lower boom 150). The vehicle function manager 312 may determine, based on a maximum lift arm extension prescribed by the operating envelope, how both the articulating arm section and the telescoping arm section need to be controlled to enforce the operating envelope. In another embodiment, the vehicle function manager 312 may further be configured to determine how the hydraulic system 325, the primary driver system 335, or some other system must be controlled to apply or enforce the operating envelope defined by the operating envelope data received at process 601.

At process 603, the vehicle function manager 312 may be configured to transmit control or command signals to various lift vehicle (e.g., the lift vehicle 100, the telehandler 200, or some other vehicle) functions according to the lift vehicle function limits defined at process 602. For example, the vehicle function manager 312 may determine that a telescoping boom of the lift arm (e.g., the boom assembly 240) may only extend to a certain length, which may correspond to a maximum extension of a hydraulic actuator associated with the telescoping boom (e.g., the telescoping cylinder of the telehandler 200). Accordingly, the vehicle function manager 312 may transmit a command to the hydraulic system 325 to limit the extension of the hydraulic actuator to limit the maximum extension of the telescoping boom of the lift arm. In another example, the vehicle function manager 312 may determine at process 602 the lift arm may only be rotated to a certain degree relative to the lift vehicle chassis. Accordingly, the vehicle function manager 312 may transmit a command signal to the hydraulic system 325 that prevents the extension of a hydraulic actuator (e.g., the lift cylinder 160, the lift cylinder 260) beyond a certain threshold limit.

In some embodiments, the vehicle function manager 312 may only be configured to transmit certain control or command signals to various lift vehicle functions if the button 319a of the interactive operator terminal 319 is in an appropriate state (e.g., pressed, selected, toggled, etc.). For example, the operator may be requesting to extend the lift arm (e.g., the boom 140, the boom assembly 240, or some other lift arm) beyond an ordinary extension limit, but one that is within the operating envelope according to the operating envelope data received at process 601. In such circumstances, the vehicle function manager 312 may provide a command or control signal to extend the lift arm further if the button 319a is in an appropriate state, according to an exemplary embodiment.

At process 604, the vehicle function manager 312 may receive new operating envelope data from the adaptive envelope generator 311, similar to the operating envelope data received at process 601. More specifically, because the adaptive envelope generator 311 may be configured to dynamically (e.g., instantaneously, continuously, in real time, etc.) alter the operating envelope of the lift vehicle (e.g., the lift vehicle 100, the telehandler 200, or some other vehicle) as circumstances change, the vehicle function manager 312 may correspondingly control various lift vehicle functions in a similarly dynamic manner. Therefore, as the adaptive envelope generator 311 determines a new or updated operating envelope for the lift vehicle as circumstances change, the vehicle function manager 312 may be configured to receive the new or updated operating envelope.

As new or updated operating envelope is received at process 604, the method 600 may return to process 602 where the vehicle function manager 312 may determine new or updated lift vehicle function limits based on the newly received operating envelope data. Thereafter, the method 600 may again proceed to process 603 where the vehicle function manager 312 may transmit a control or command signal to facilitate the operation of the lift vehicle (e.g., the lift vehicle 100, the telehandler 200, or some other vehicle) according to the new or updated operating envelope. In this way, the method 600 may be iterative such that the vehicle function manager 312 is regularly or continuously moderating the operation of the lift vehicle based on the received operating envelope data.

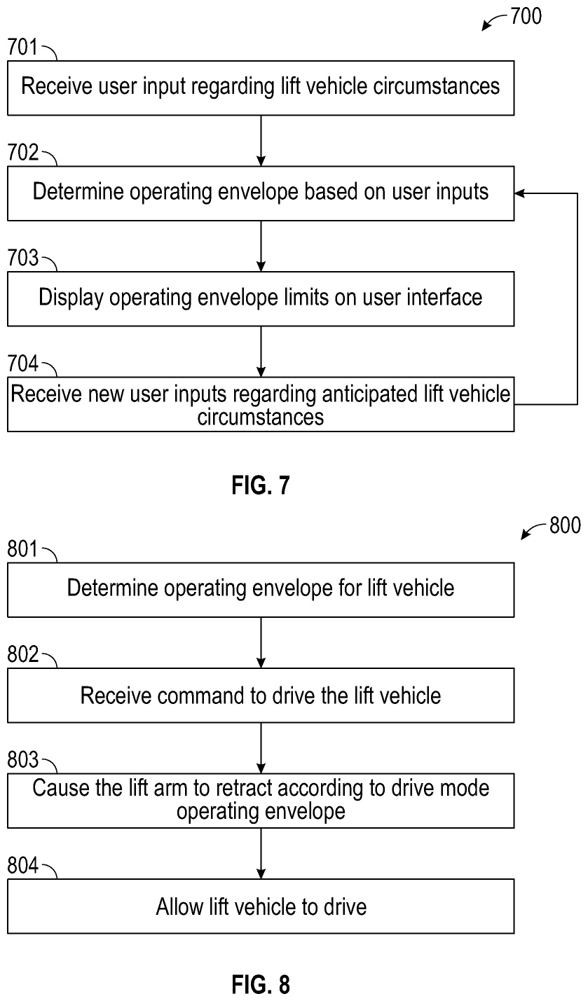

Referring now to FIG. 7, a flow chart of a method 700 of planning an operation of a lift vehicle having an adaptive envelope system is shown, according to an exemplary embodiment. The method 700 may be performed by the interactive operator terminal 319 of the control system 300 as shown in FIGS. 3 and 4, according to an exemplary embodiment.

At process 701, the interactive operator terminal 319 may receive a user input regarding lift vehicle circumstances, according to an exemplary embodiment. As indicated above, and as will be discussed below with respect to FIG. 8, the interactive operator terminal 319 may be a computer, tablet device, touch screen device, or similar device that is configured to receive input from a user, such as a lift vehicle operator. In one embodiment, the interactive operator terminal 319 may be a touch screen device mounted on a body (e.g., the base 112 or the turntable 114) of the lift vehicle (e.g., the lift vehicle 100) or within a cab (e.g., the cabin 220) of the lift vehicle (e.g., the telehandler 200).

A user may interact with the interactive operator terminal 319 to plan a lift vehicle operation to determine whether or how to proceed with an operation using the lift vehicle (e.g., the lift vehicle 100, the telehandler 200, or some other vehicle). For example, a user may wish to deliver a payload to the roof of a building. The user may input the anticipated load (e.g., a weight of the payload or a portion thereof) and the anticipated extension of the lift arm (e.g., a desired height at which the payload may be delivered). The user may also input various other inputs, such as the anticipated angular orientation of the vehicle base relative to a reference plane, anticipated rotation of the lift arm, etc.

At process 702, the control system 300, namely the adaptive envelope generator 311 of the controller 305, may determine an operating envelope for the lift vehicle (e.g., the lift vehicle 100, the telehandler 200, or some other vehicle) based on the user inputs received at process 701. The determination made by the adaptive envelope generator 311 may be similar to the determination described above with reference to the method 500 at process 502. However, at process 702, the adaptive envelope generator 311 may determine an operating envelope based in part on the user input provided to the interactive operator terminal 319 at process 701. Put another way, the operating envelope determined by the adaptive envelope generator 311 at process 702 may not be based upon the present circumstances of the lift vehicle (e.g., the lift vehicle 100, the telehandler 200, or some other vehicle) as measured by sensors (e.g., the load sensor 315, the vehicle base inclination sensor 316, the rotation sensor 317, or the boom length sensor 318), but may instead be based upon the anticipated or desired future circumstances of the lift vehicle as represented by the user inputs received at process 701.

At process 703, the controller 305 may display the operating envelope determined at process 702 on the interactive operator terminal 319. More particularly, the controller 305 may cause the interactive operator terminal 319 to display a visual representation of the operating envelope. The visual representation of the operating envelope may be supplemented by additional information, such as numerical representation of the maximum or minimum lift arm extension length, maximum or minimum lift arm angle of rotation, etc. In this way, the interactive operator terminal 319 may provide the user with relative details about an operating envelope that would be enforced by the control system 300 in the event the user proceeds with the planned or desired operation (e.g., lifting a payload to a desired height). Upon viewing the information regarding the operating envelope, the user may determine whether to proceed with the desired operation or whether to alter plans for the desired operation (e.g., lift fifty percent of the payload at a time rather than one hundred percent).

Should the user determine to revise the plans for the desired operation, the interactive operator terminal 319 may receive new user inputs regarding the anticipated lift vehicle circumstances at process 704. The method 700 may then return to process 702 to determine an operating envelope based in part on the user inputs received at process 704, according to an exemplary embodiment. Therefore, the method 700 may be iterative such that one or more users may provide multiple user inputs to the interactive operator terminal 319, whereupon an operating envelope will be determined by the adaptive envelope generator 311 and displayed on a display device of the interactive operator terminal 319.

Referring now to FIG. 8, a flow chart of a method 800 of driving a lift vehicle (e.g., the lift vehicle 100, the telehandler 200, or some other vehicle) with an adaptive envelope system is shown. The method 600 may be performed by the adaptive envelope generator 311 and the vehicle function manager 312 of the controller 305 as shown in FIGS. 3 and 4, according to an exemplary embodiment.

At process 801, the adaptive envelope generator 311 may determine a suitable operating envelope for the lift vehicle (e.g., the lift vehicle 100, the telehandler 200, or some other vehicle), as described above with reference process 502 shown in FIG. 5. The operating envelope may be determined by data collected from various sources (e.g., sensors, etc.), where the data is indicative of a current state or condition of the lift vehicle and associated components.

At process 802, the controller 305 may receive a command from an operator to drive the lift vehicle (e.g., the lift vehicle 100, the telehandler 200, or some other vehicle). For example, the command to drive the lift vehicle can be a command to move the lift vehicle along a ground surface using tractive elements (e.g., the tractive elements 116 or the tractive elements 216). More particularly, the vehicle function manager may receive a command to drive the lift vehicle, where the command was provided via the interactive operator terminal 319 (e.g., a touch screen, buttons, etc.). As may occur during ordinary operation of the lift vehicle, the command to drive the lift vehicle may be received while the lift vehicle is performing some other function, such as lifting a payload to a destination high above the ground such that the lift arm (e.g., the boom 140, the boom assembly 240, or some other lift arm) is extended. For example, the lift arm may be extended to a limit of the operating envelope received at process 801.

At process 803, the vehicle function manager 312 may not allow the lift vehicle (e.g., the lift vehicle 100, the telehandler 200, or some other vehicle) to drive until the lift arm (e.g., the boom 140, the boom assembly 240, or some other lift arm) is in an appropriate position. According to an exemplary embodiment, the lift arm must be in a position that would not create any unsafe or unstable circumstances while the lift vehicle is in motion (e.g., driving), as may occur if the lift vehicle is moving on uneven or rugged terrain. To ensure the lift vehicle remains stable, the vehicle function manager 312 may require that the lift arm be in a position that is within a drive mode operating envelope. The drive mode operating envelope defines a maximum extension of the lift arm that is less than an extension allowed by the operating envelope determined at process 801, for example. Accordingly, the vehicle function manager 312 may cause the lift arm to retract to a position within the drive mode operating envelope. In another embodiment, the vehicle function manager 312 may prompt the operator to move the lift arm to an appropriate position via an alert, notification, or some other type of indication. In any case, the vehicle function manager 312 may be configured to prevent the operator from driving the lift vehicle until the lift arm is within the drive mode operating envelope, according to an exemplary embodiment.

In process 804, the vehicle function manager may determine that the lift arm (e.g., the boom 140, the boom assembly 240, or some other lift arm) is within the drive mode operating envelope and correspondingly allow the operator to drive the lift vehicle (e.g., the lift vehicle 100, the telehandler 200, or some other vehicle). In some embodiments, the vehicle function manager 312 may limit the driving functionality of the lift vehicle in order to further ensure that an unsafe or unstable. For example, the vehicle function manager 312 may impose a maximum speed (e.g., a “creep” speed) and may prevent the lift vehicle from exceeding that speed while the drive mode is active. In other embodiments, the vehicle function manager 312 may determine an allowable maximum speed for the lift vehicle based on various parameters, such as the load on the lift arm. For example, the allowable maximum speed for the lift vehicle may depend upon the magnitude of the load applied to the lift arm, where the maximum speed might be lower for a heavier load and higher for a lighter load, according to an exemplary embodiment.

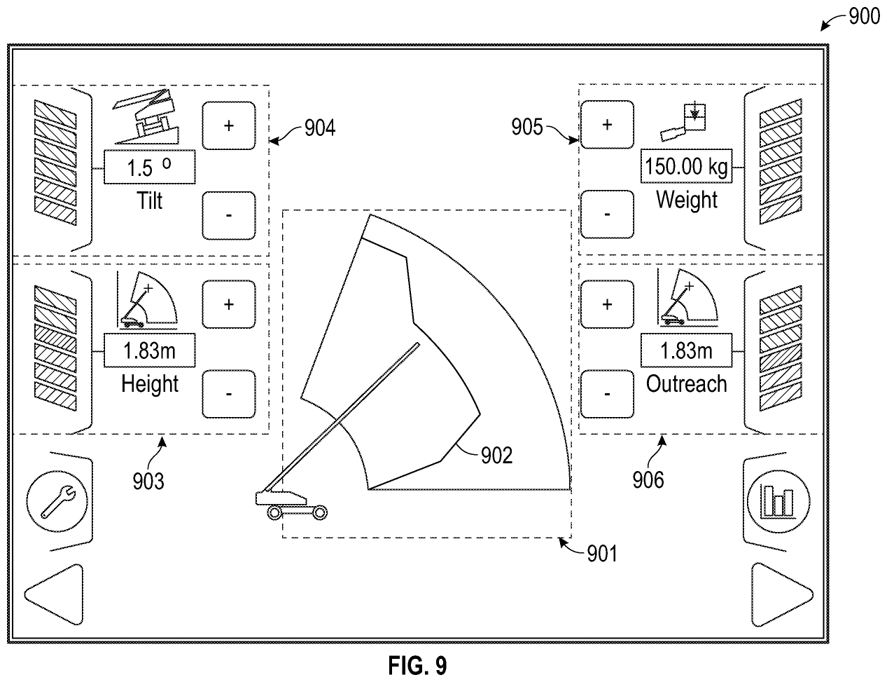

Referring now to FIG. 9, a diagram of a graphical user interface 900 of a lift vehicle (e.g., the lift vehicle 100, the telehandler 200, or some other vehicle) having an adaptive envelope system is shown, according to an exemplary embodiment. In particular, the graphical user interface 900 may display a visual representation of the operating envelope as determined by the adaptive envelope generator 311 discussed above. Whether determined via method 500 shown in FIG. 5, method 700 shown in FIG. 7, or some other process, an operating envelope may be displayed on the graphical user interface 900. Displaying the operating envelope may duly inform the operator of the limits of the lift vehicle according to the operating envelope (e.g., how far the lift arm may extend based on the operating envelope) or the status of the lift vehicle relative to the operating envelope (e.g., the position of the lift arm (e.g., the boom 140, the boom assembly 240, or some other lift arm) relative to a boundary established by the operating envelope). Moreover, the graphical user interface 900 may display information relating to a variety of lift vehicle parameters, such as the tilt of the lift vehicle chassis relative to a horizontal reference plan, the weight of a load lifted by the lift vehicle, the height of the lift arm from a ground surface (e.g., a vertical component of the lift arm position), the outreach of the lift arm from the lift vehicle (e.g., a horizontal component of the lift arm position), or some other parameter.

According to an exemplary embodiment, the graphical user interface 900 may be displayed on the interactive operator terminal 319 as discussed above. In another embodiment, the graphical user interface 900 may be displayed on some other device, such as a mobile device, tablet computer, etc. In yet another embodiment, the graphical user interface 900 may be web-based and may thus be presented on a variety of devices having access to a web browser or other software application (e.g., mobile application, etc.). The graphical user interface 900 may be interactive such that a user may interact various selectable widgets, icons, sliders, graphs, etc. to provide user input. For example, in embodiments where the graphical user interface 900 is displayed on the interactive operator terminal 319, which itself is further coupled to the controller 305 as shown in FIG. 3, the graphical user interface 900 may include various widgets that, when selected, control the lift vehicle (e.g., the lift vehicle 100, the telehandler 200, or some other vehicle) via the controller 305. According to an exemplary embodiment, a user may interact with the graphical user interface 900 to both control the lift vehicle while the lift vehicle is in operation or to plan an operation of the lift vehicle in a planning mode.

As shown in FIG. 9, the graphical user interface 900 may include an operating envelope widget 901 displaying the operating envelope. According to an exemplary embodiment, the operating envelope widget 901 may display a visual representation of the operating envelope, shown as boundary 902, while also presenting information related a position of the lift arm (e.g., the boom 140, the boom assembly 240, or some other lift arm) of the lift vehicle (e.g., the lift vehicle 100, the telehandler 200, or some other vehicle) relative to the boundary 902. The widget 901 may be configured to update in real-time or periodically such that changes to the operating envelope or lift arm position may be depicted in widget 901 of the graphical user interface 900.

The graphical user interface 900 may further include a height widget 903, a tilt widget 904, a weight widget 905, an outreach widget 906, or some other widget or widgets related to various other lift vehicle parameters or circumstances, according to an exemplary embodiment. The height widget 903 may include a graphical depiction and/or numerical representation of the height of the lift arm (e.g., the boom 140, the boom assembly 240, or some other lift arm) from a reference point, such as the ground surface. The height widget 903 may be configured to receive user input, such as via the interactive operator terminal 319. A user input may control the height of the lift arm while the lift vehicle (e.g., the lift vehicle 100, the telehandler 200, or some other vehicle) is in operation (e.g., move the lift arm to adjust the height thereof) or may alter the operating envelope depicted in the operating envelope widget 901 while the user is engaged in a planning operation, such as that described above with reference to FIG. 7. The tilt widget 904 may include a graphical depiction and/or numerical representation of the angular orientation of a base of the lift vehicle relative to a reference plane, such as a horizontal plane. The tilt widget 904 may be configured to receive user input, such as via the interactive operator terminal 319. A user input may control the tilt of the lift vehicle while the lift vehicle is in operation (e.g., by articulating the stabilizers 217 to adjust the angular orientation of the lift vehicle) or may adjust the anticipated angular orientation of the lift vehicle to correspondingly adjust the operating envelope depicted in the operating envelope widget 901 while the user is engaged in a planning operation, such as that described above with reference to FIG. 7.

The weight widget 905 may include a graphical depiction and/or numerical representation of the weight of a load applied to the lift arm (e.g., the boom 140, the boom assembly 240, or some other lift arm). The weight widget 905 may be configured to receive user input, such as via the interactive operator terminal 319. A user input may adjust the anticipated load applied to the lift arm in order to correspondingly adjust the operating envelope depicted in the operating envelope widget 901 while the user is engaged in a planning operation, such as that described above with reference to FIG. 7. The outreach widget 906 may include a graphical depiction and/or numerical representation of the outreach of the lift arm (e.g., the boom 140, the boom assembly 240, or some other lift arm) from a reference point, such as the ground surface. The outreach widget 906 may be configured to receive user input, such as via the interactive operator terminal 319. A user input may control the outreach of the lift arm while the lift vehicle (e.g., the lift vehicle 100, the telehandler 200, or some other vehicle) is in operation (e.g., extend the lift arm to adjust the outreach thereof) or may adjust the anticipated outreach of the lift arm to correspondingly adjust the operating envelope depicted in the operating envelope widget 901 while the user is engaged in a planning operation, such as that described above with reference to FIG. 7. In various other embodiments, the graphical user interface 900 may include additional widgets, fewer widgets, or other widgets depicting other lift vehicle parameters or presenting other information.

### Adaptive Envelope System with Chassis Footprint

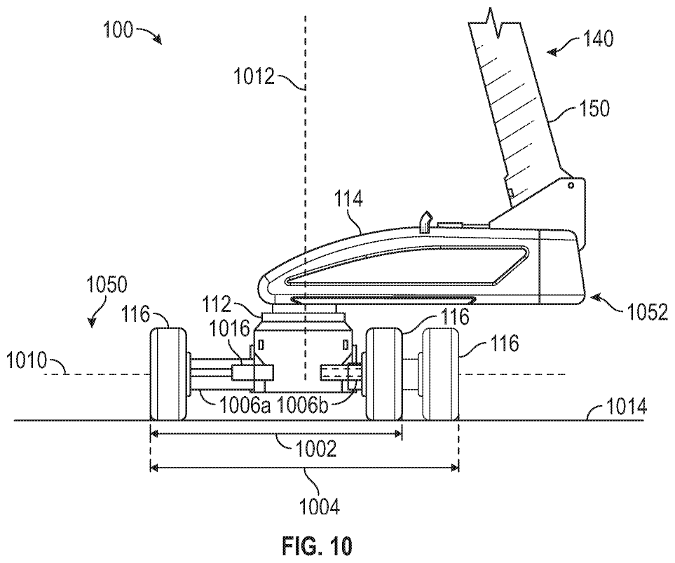

Referring to FIGS. 10-16, the operating envelope may be determined (e.g., by the controller 305 based on a footprint of the lift vehicle 100, according to an exemplary embodiment. The footprint of the lift vehicle 100 may indicate an overall width in a direction of the lift vehicle 100 between tractive elements 116 that contact a ground surface 1014 upon which the lift vehicle 100 rests. Tractive elements 116 on opposite sides of the lift vehicle 100 may be coupled with the lift base 112 through telescoping or extendable chassis members, shown as chassis axles 1006. The chassis axles 1006 may be driven to extend or retract by actuators 1016 (e.g., motors, pneumatic actuators, hydraulic actuators, hydraulic motors, etc.) in order to adjust the footprint of the lift vehicle 100.

When the footprint of the lift vehicle 100 is increased, a distance between the tractive elements 116 generally increases which results in improved counter-forces provided by the tractive elements 116. For example, the increased distance may result in increased counter-moments to allow increased moments due to lifting of the platform assembly 192, and therefore allow extended range of the platform assembly 192. On the other hand, when the distance between the tractive elements 116 is decreased (e.g., the footprint of the lift vehicle 100 is decreased) due to retraction of the actuators 1016, the lift vehicle 100 may be able to withstand reduced tipping moments. In this way, the footprint of the lift vehicle 100 may be adjustable and can result in different operating envelopes for the lift vehicle 100. Specifically, the operating envelopes may be reduced in a direction along which the footprint of the lift vehicle 100 is reduced.

In some embodiments, the chassis axles 1006 are each independently operable to extend or retract. The chassis axles 1006 may be infinitely variable between an inner position (e.g., a tucked or stowed position) and an outer position (e.g., an extended or deployed position). In some embodiments, the chassis axles 1006 are independently transitionable between a first predetermined position and a second predetermined position. For example, the chassis axles 1006 may be transitionable between the tucked or stowed position and the extended or deployed position. The chassis axles 1006 are driven between the tucked or stowed position and the extended or deployed position by operation of the actuators 1016. The actuators 1016 may transition between the tucked or stowed position and the extended or deployed position responsive to a command from a user (e.g., a command provided via a human machine interface (HMI) such as the interactive operator terminal 319). Transitioning the actuators 1016 between the tucked or stowed position and the extended or deployed position causes the chassis axles 1006 to extend or retract which results in changes to the footprint of the lift vehicle 100.

As shown particularly in FIG. 10, a first chassis axle 1006a (e.g., a pair of the chassis axles 1006a on a first side 1050 of the lift vehicle 100) is shown in the fully extended (e.g., the deployed position), whereas a second chassis axle 1006b (e.g., a pair of the chassis axles 1006b on a second side 1052 of the lift vehicle 100) is shown in the fully tucked or stowed (e.g., retracted) position. The lift vehicle 100 has an overall footprint width 1002 when the first chassis axle 1006a is fully extended and the second chassis axle 1006b is fully retracted. While the lift vehicle 100 has the overall footprint width 1002 in the configuration shown in FIG. 10, the lift vehicle 100 may have an overall footprint width 1004 if the second chassis axle 1006b were fully extended. Accordingly, the lift vehicle 100 in the configuration shown in FIG. 10 is operated in a limited mode on the second side 1052. In this way, the lift vehicle 100 may be capable of operating according to a full operational envelope on the first side 1050, but not on the second side 1052.

The chassis axles 1006 are extendable and retractable in a lateral direction along a lateral axis 1010. The lateral axis 1010 may be substantially parallel with the ground surface 1014. In this way, the chassis axles 1006 may be extended and retracted in the lateral direction (e.g., in a direction substantially parallel with the ground surface 1014). The boom 140 may be configured to raise or lower the platform assembly 192 in the vertical direction 1012, as well as in lateral or longitudinal directions at different heights along the vertical direction 1012. When the platform assembly 192 is moved in the lateral direction beyond the tractive elements 116 on the first side 1050 of the lift vehicle 100, a tipping moment may be produced which is countered by a counter-moment of the tractive elements 116 on the first side 1050. Similarly, when the platform assembly 192 is moved in the lateral direction beyond the tractive elements 116 on the second side 1052 of the lift vehicle 100, a tipping moment may be produced which is countered by a counter-moment of the tractive elements 116 on the second side 1052. In this way, extending or retracting the chassis axles 1006 may adjust a moment arm of the tractive elements 116 which may change the counter-moments that the lift vehicle 100 is capable of providing. The boom 140 may be limited from producing moments (e.g., due to raising the moving the platform assembly 192) that would result in exceeding the counter-moment or a factor of safety that is providable by the tractive elements 116 given current extension or retraction of the chassis axles 1006. FIG. 10 illustrates a case of “short-jacking.” Short-jacking may refer to the extension of one side of the lift vehicle 100 such as when the chassis axles 1006a on the first side 1050 are extended while the chassis axles 1006b on the second side 1052 are retracted in order to reduce overall footprint of the lift vehicle 100 and allow room along the side of the lift vehicle 100 (e.g., such that the lift vehicle 100 does not take up excessive space in a road).

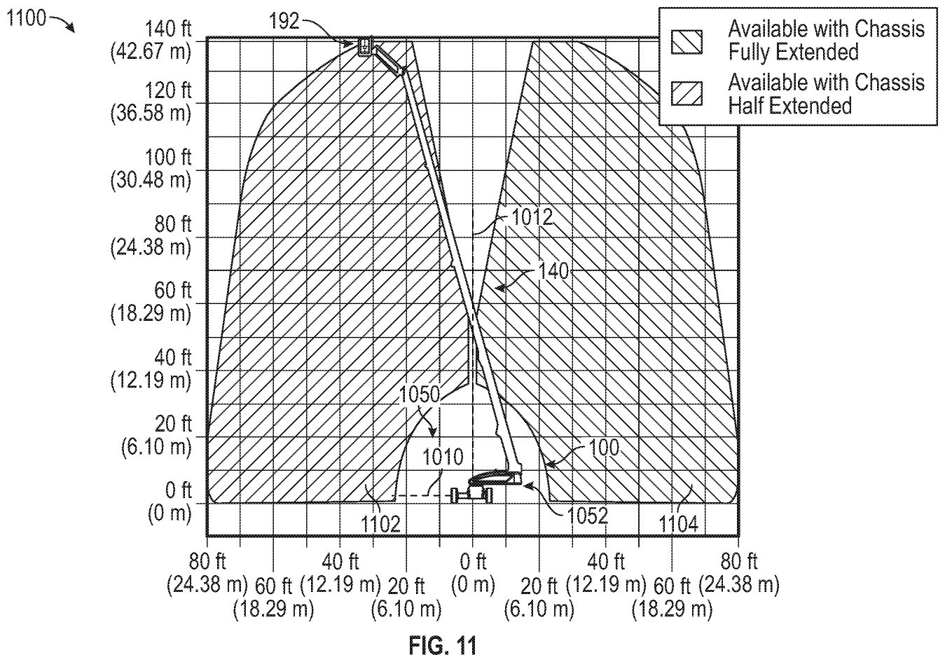

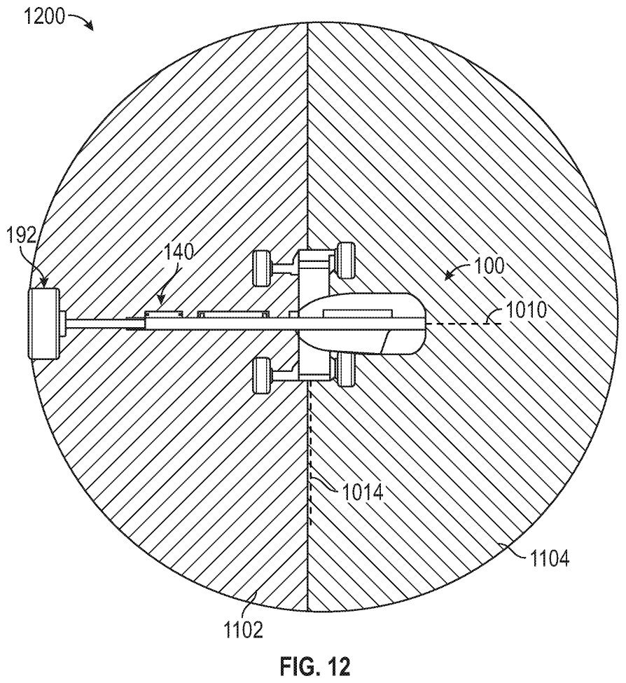

Referring to FIGS. 11 and 12, a diagram 1100 and a diagram 1200 illustrate reach or operational envelops of the lift vehicle 100 in the configuration shown in FIG. 10. As shown in FIG. 11, the diagram 1100 illustrates a full operational envelope 1102 on the first side 1050 of the lift vehicle 100 and a limited operational envelope 1104 on the second side 1052 of the lift vehicle 100. As shown in FIGS. 11 and 12, the limited operational envelope 1104 is limited or restricted from use (e.g., the boom 140 is limited from moving the platform assembly 192 into the limited operational envelope 1104) when the chassis axle 1006b is in the stowed position as shown in FIG. 10. In some embodiments, the full operational envelope 1102 is a reduced operational envelope. The limited operational envelope 1104 may be available if the chassis axle 1006b is fully extended (e.g., transitioned into the fully extended or deployed position). The limited operational envelope 1104 is limited by the controller 305 based on the degree of extension or retraction of the chassis axles 1006 on the side 1052 of the lift vehicle 100 corresponding to the limited operational envelope 1104. In this way, the lift vehicle 100 may have a full reach or operational envelope for use by the boom 140 (e.g., the boom 140 may operate to move the platform assembly 192 about the full operational envelope 1102) on a side of the lift vehicle 100 where the chassis axles 1006 are fully extended, and may have a limited or restricted envelope on a side of the lift vehicle 100 where the chassis axles 1006 are not fully extended.

Referring particularly to FIG. 12, the lift vehicle 100 may include a longitudinal axis 1014 that is perpendicular to both the lateral axis 1010 and the vertical axis 1012. The longitudinal axis 1014 and the lateral axis 1010 may define a plane that is substantially parallel with the ground surface 1014. The vertical axis 1012 may extend generally or substantially perpendicular to the ground surface 1014 in order to raise or lower the platform assembly 192 along the vertical axis 1012.

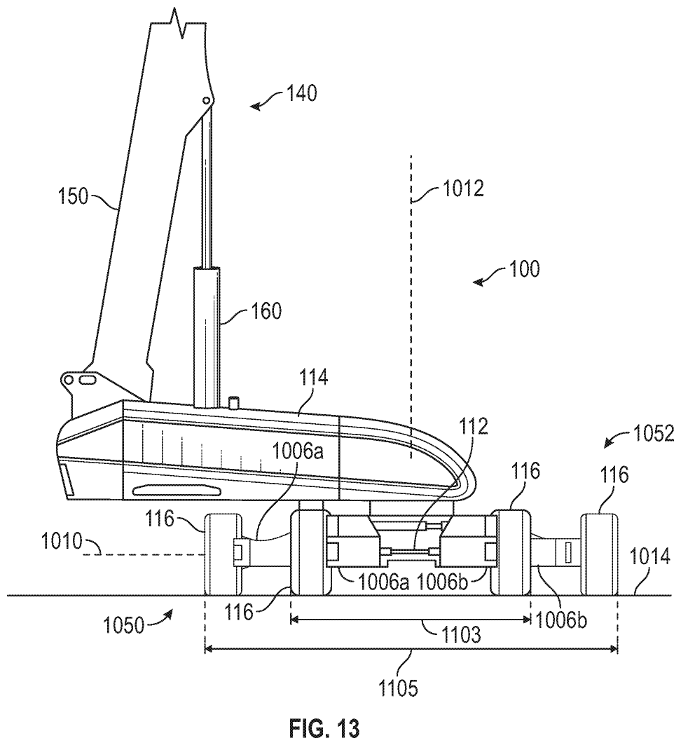

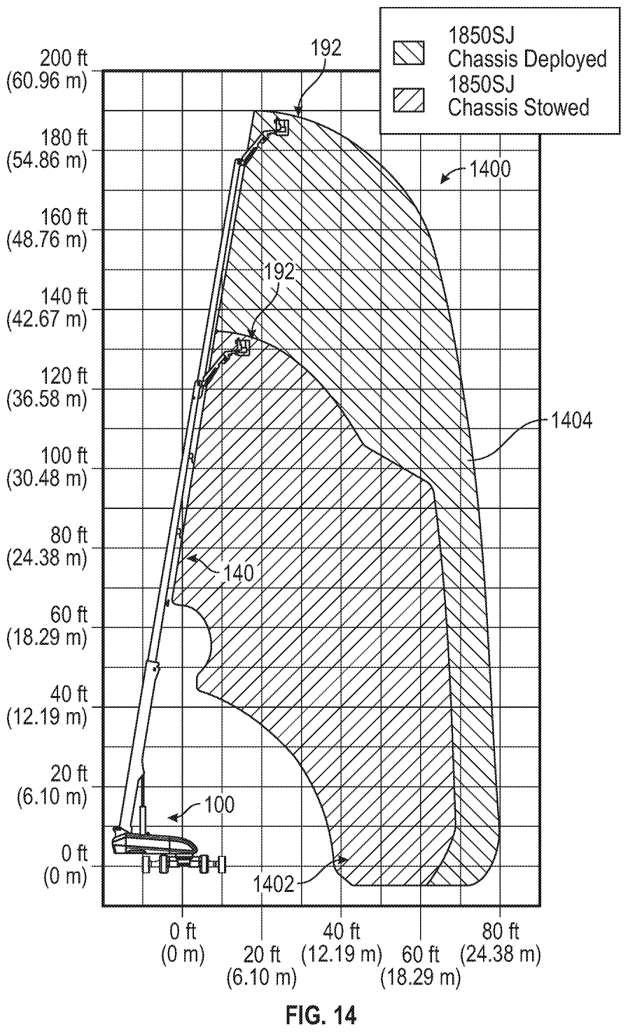

Referring to FIGS. 13-14, the lift vehicle 100 includes the first chassis axle 1006a and the second chassis axle 1006b in stowed or tucked positions. As shown in FIG. 13, the lift vehicle 100 has an overall footprint width 1103 when the first chassis axle 1006a and the second chassis axle 1006b are in the stowed or tucked positions. The lift vehicle 100 may have an overall footprint width 1105 when the first chassis axle 1006a and the second chassis axle 1006b are in the extended positions, the overall footprint width 1105 being greater than the overall footprint width 1002. Accordingly, in the configuration as shown in FIG. 13, the lift vehicle 100 is in a reduced footprint arrangement, with the footprint of the lift vehicle 100 reduced on both the first side 1050 and the second side 1052.

Referring to FIG. 14, a diagram 1400 illustrates an overall operational envelope 1404 and a reduced operational envelope 1402. The overall operational envelope 1404 represents ranges of locations that are allowed to be reached by the platform assembly 192 when the chassis axles 1006 are fully extended. The reduced operational envelope 1402 represents ranges of locations that are allowed to be reached by the platform assembly 192 when the chassis axles 1006 are retracted (e.g., tucked or stowed). As shown in FIG. 14, when the chassis axles 1006 are retracted, the boom 140 is limited to the reduced operational envelope 1402. The reduced operational envelope 1402 may be a scaled version of the overall operational envelope 1404. The reduced operational envelope 1402 may be a subset of the overall operational envelope 1404. The reduced operational envelope 1402 may be a predetermined envelope that is determined based on a moment analysis (e.g., predicting expected moments due to positioning of the platform assembly 192 at different locations about the reduced operational envelope 1402) given a corresponding degree of extension or retraction of the chassis axles 1006. Generally speaking, as the chassis axles 1006 are retracted, a distance or length of a counter-moment arm provided by the tractive elements 116 and the chassis axles 1006 reduces which decreases a size or span of the reduced operational envelope 1402.

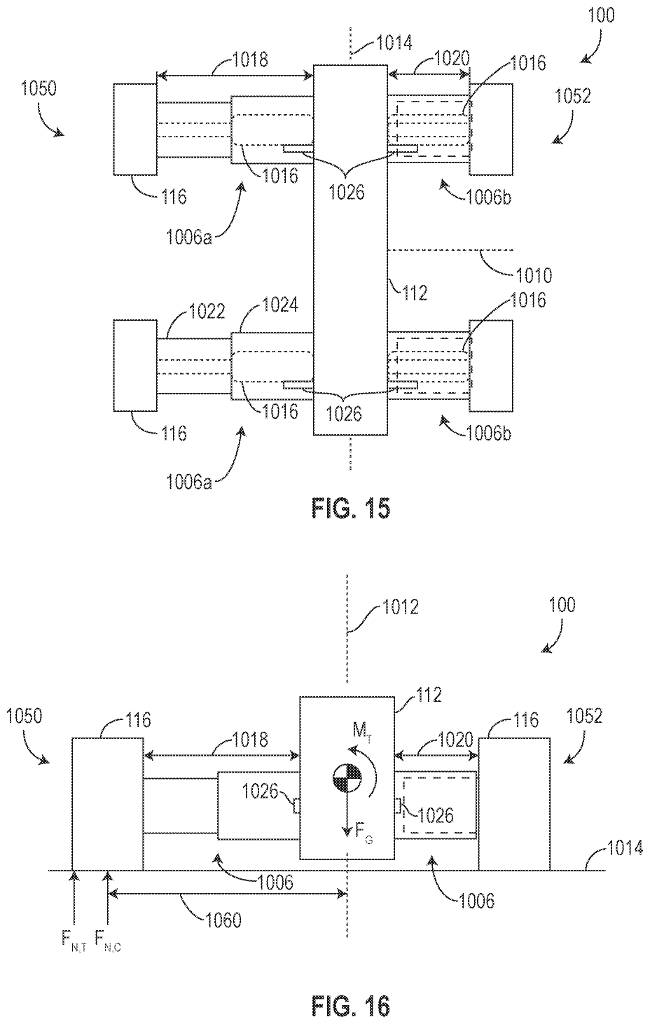

Referring to FIGS. 15-16, the lift vehicle 100 includes sensors 1026 that are configured to measure a degree of extension or retraction of each of the chassis axles 1006. For example, each of the chassis axles 1006 may be telescoping members including an inner member 1022 that is received within and translates relative to an outer member 1024. The inner member 1022 and the outer member 1024 are configured to extend or retract in order to increase or decrease the length of the chassis axles 1006. For example, as shown in FIGS. 15 and 16, the chassis axles 1006a are shown fully extended, whereas the chassis axles 1006b are fully retracted (e.g., tucked, stowed, etc.). It should be understood that any of the chassis axles 1006 may be independently operated or driven between the extended position (e.g., the chassis axles 1006a as shown in FIGS. 15 and 16) and the retracted position (e.g., the chassis axles 1006b as shown in FIGS. 15 and 16). The sensors 1026 may be configured to obtain feedback from the actuators 1016 or motors that drive extension and retraction of the chassis axles 1006, or may be distance sensors configured to measure the degree of extension or retraction of the chassis axles 1006 directly. In some embodiments, the sensors 1026 are configured to obtain measurements or signals indicative of the degree of extension or retraction of the chassis axles 1006.

Referring still to FIGS. 15-16, the chassis axles 1006 can be extended or retracted between multiple predetermined positions (e.g., a first predetermined position, a deployed position, an extended position, and a second predetermined position, a retracted position, a stowed position, a tucked position, etc.). The chassis axles 1006 may also be continuously extended or retracted between different positions. The degree of extension or retraction of each of the chassis axles 1006 (e.g., at the predetermined positions, at continuous positions, etc.) can be directly measured by the sensors 1026, or may be identified based on feedback from the actuators 1016.

Referring still to FIGS. 15 and 16, extension of the chassis axles 1006 results in an increased length 1018 of the chassis axles 1006, and a corresponding increase to a distance 1060 between a center of the lift base 112 and a center of the corresponding tractive element 116. During use of the lift vehicle 100, a tipping moment M_{T} is produced due to elevation of the platform assembly 192. A weight of the lift base 112 may produce a counter-moment to cancel a portion of the tipping moment M_{T}. Similarly, the tractive elements 116 may provide a counter-moment to cancel a portion of the tipping moment M_{T}. The counter-moment provided by the tractive elements 116 may be directly related to the length 1018 of the chassis axles 1006 such that increased length 1018 of the chassis axles 1006 results in increased moment arm of the counter-moment provided by the tractive elements 116. The tractive elements 116 may provide a resulting normal force F_{N,C} that under normal conditions is centered at the tractive elements 116 and produces the counter-moment provided by the tractive elements 116. If the resulting normal force F_{N,C} exceeds based an outer periphery of the tractive elements 116 (F_{N,T}), tipping may occur at the lift vehicle 100. Accordingly, the lift vehicle 100 may be limited (e.g., via controls or via length of components of the lift vehicle 100) such that tipping does not occur. Similarly, when the chassis axles 1006 are in the retracted position (e.g., such that the distance is distance 1020), while the moment arm provided by the tractive elements 116 may decrease, the lift vehicle 100 may still be able to sustain some degree of tipping moment M_{T} safely, and the boom 140 may be operated in a limited manner (e.g., according to a reduced envelope).

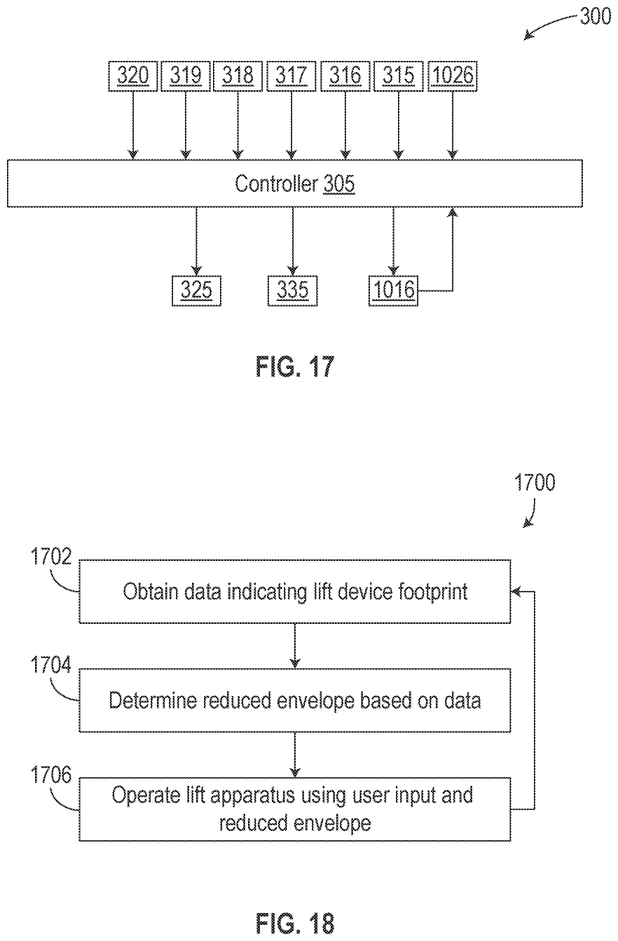

Referring to FIG. 17, a diagram of the control system 300 of the lift vehicle 10 includes the controller 305 and similar inputs and outputs as described in greater detail above with reference to FIG. 1. The control system 300 also includes the sensors 1026 that measure the degree of extension or retraction of the chassis axles 1006. In some embodiments, the controller 305 is configured to obtain feedback from the actuators 1016 to determine the degree of extension or retraction of the chassis axles 1006. The controller 305 is configured to identify the degree of extension or retraction of each of the chassis axles 1006 and limit operation of the boom 140 in order to maintain the tipping moment below a threshold. For example, if the controller 305 identifies, based on the feedback of the actuators 1016 or the sensor data provided by the sensors 1026, that the chassis axles 1006 are retracted or in a stowed position on a first side of the lift vehicle 100, the controller 305 may determine a reduced envelope on the first side of the lift vehicle 100 and prevent the boom 140 from being operated to reach beyond the reduced envelope. In some embodiments, the chassis axles 1006 are infinitely variable between fully extended and fully retracted positions and the controller 305 is configured to scale the reduced envelope based on the degree of extension or retraction of the chassis axles 1006. In some embodiments, the chassis axles 1006 are transitionable between different predetermined locations (e.g., stowed and fully deployed) and the controller 305 selects between different predetermined reduced envelopes.

When the chassis axles 1006 are not fully deployed and the controller 305 has selected or generated a reduced envelope, the controller 305 may restrict operation of the boom 140 beyond the reduced envelope. For example, the controller 305 may receive inputs from the terminal 319 to operate the boom 140 to reach beyond a border of the reduced envelope and prevent the boom 140 from being operated beyond the reduced envelope. The controller 305 may operate or limit operation of the boom 140 by operating the hydraulic system 325. The controller 305 can also be configured to operate a display screen or unit of the terminal 319 in order to notify the operator that the boom 140 can not be operated beyond the current point unless the chassis axles 1006 are extended. The chassis axles 1006 may be operated by the controller 305 to extend or retract by receiving an input from the terminal 319 and operating the actuators 1016 according to the input from the terminal 319.

Referring to FIG. 18, a flow diagram of a process 1700 for operating or restricting operation of a lift device based on a footprint includes steps 1702-1706, according to some embodiments. The process 1700 can be performed by the controller 305 based on the detected degree of extension or retraction of one or more chassis axles that control the footprint of the lift device. The process 1700 can be performed in a real-time manner such that an envelope is determined based on the current degree of extension or retraction of chassis axles or stabilizers which directly relates to a footprint width of the lift vehicle 100.

The process 1700 includes obtaining data indicating a footprint of a lift device (step 1702), according to some embodiments. Step 1702 can include obtaining sensor feedback from sensors 1026 that directly measure a degree of extension or retraction of an extendable member which adjusts the footprint of the lift device. Step 1702 can also include obtaining feedback from an actuator that operates to drive the extendable member to extend or retract and estimating or determining the footprint of the lift device based on the feedback from the actuator. Step 1702 can be performed by the controller 305 by receiving data from the sensors 1026 or feedback from the actuators 1016.

The process 1700 includes determining a reduced envelope based on the data (step 1704), according to some embodiments. In some embodiments, step 1704 is performed by the controller 305 by using an estimate of the footprint of the lift device (e.g., the lift vehicle 100), or the data obtained from the actuators 1016 or the sensors 1026. The reduced envelope may be determined by the controller 305 using a moment analysis in order to maintain a tipping moment of the lift device below a threshold for any position of a boom assembly or reach apparatus of the lift device within the reduced envelope. In some embodiments, the reduced envelope is scaled or determined based on the degree of extension or retraction of the chassis axles 1006. In some embodiments, the reduced envelope is a predetermined envelope or selected from a database of discrete envelopes based on the degree of extension or retraction of the lift device.

The process 1700 includes operating a lift apparatus using the user input and the reduced envelope (step 1706), according to some embodiments. In some embodiments, step 1706 include operating hydraulic actuators or linear electric actuators of the lift apparatus of the lift device until an end (e.g., a platform assembly) of the lift apparatus reaches a boundary of the reduced envelope. Once the end of the lift apparatus reaches the boundary of the reduced envelope, the lift apparatus is prevented or limited from reaching beyond the boundary of the reduced envelope. Process 1700 can return to step 1702 in response to step 1706. Advantageously, process 1700 can be implemented for a lift device in order to allow the lift device to reach within a reduced envelope even when stabilizers or chassis axles are not fully deployed.

### Roto-Handler

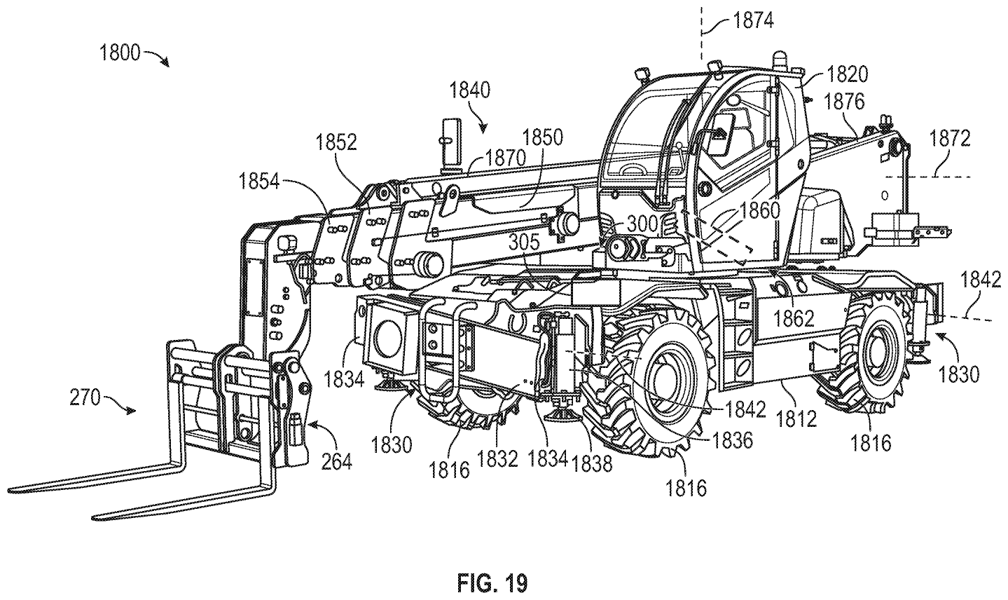

Referring to FIG. 19, the control system 300 can be implemented on a roto-handler 1800. The roto-handler 1800 can implement portions of the lift vehicle 100 and the telehandler 200. The roto-handler 1800 includes a frame 1812 (e.g., a chassis), tractive elements 1816 (e.g., wheels) coupled with the frame 1812, a cabin 1820, and a boom assembly 1840. The roto-telehandler 1800 also includes a turntable assembly 1862 that rotatably couples the cabin 1820 and the boom assembly 1840 with the frame 1812. The turntable assembly 1862 can be operated by an electric motor to drive the cabin 1820 and the boom assembly 1840 to rotate relative to the frame 1812 about a vertical axis 1874.

The boom assembly 1840 can be similar to the boom assembly 240. The boom assembly 1840 is a telescoping assembly having a series of nested members including a proximal or base section 1850, an intermediate or middle section 1852, and a distal or fly section 1854. The base section 1850 is pivotally coupled to the rear end of the frame 1812 such that the boom assembly 1840 is pivotable about a lateral axis 1872. More particularly, the boom assembly 1840 may be coupled to the telehandler 200 at a boom pivot that is rearward of the cabin 1820. The middle section 1852 is received within the base section 1850 and extends outward beyond the base section 1850. The fly section 1854 is received within the middle section 1852 and extends outward beyond the middle section 1852. In other embodiments, the middle section 1852 is omitted, and the fly section 1854 is received directly within the base section 1850. In yet other embodiments, the boom assembly 1840 includes multiple middle sections 1852. The base section 1850, the middle section 1852, and the fly section 1854 are each slidably coupled to one another to facilitate varying an overall length of the boom assembly 1840. Specifically, the middle section 1852 is slidably coupled to the base section 1850, and the fly section 1854 is slidably coupled to the middle section 1852. The boom assembly 1840 can include five sections that form the telescoping boom assembly 1840. The sections can be driven via chains and a motor.

The boom assembly 1840 further includes a tool, manipulator, interface or implement, shown as implement 270, coupled to a distal end of the fly section 254. The implement 270 may be pivotally coupled to the fly section 254 such that the implement 270 is pivotable relative to the fly section 254 about a lateral axis. The implement 270 may facilitate interfacing the boom assembly 1840 with materials (e.g., wood, hay, building materials, etc.) or one or more operators or users. The implement 270 may be powered (e.g., by pressurized hydraulic fluid from a hydraulic system) or unpowered. As shown in FIG. 19, the implement 270 is a fork mechanism comprising a plurality of tines which are configured to lift a palletized payload. For example, the implement 270 can be a pair of forks (e.g., two fork tines), such as forks structured to lift a pallet. In other embodiments, the implement 270 is a bucket, a material handling arm, a boom, a hook, a hopper, a sweeper, a grapple, or another type of implement configured to handle material. In other embodiments, the implement 270 is a work platform configured to support one or more operators. In some embodiments, the implement 270 is selectively coupled to the fly section 1854 such that the implement 270 is interchangeable with other implements. By way of example, the forks shown in FIG. 19 may be removed and exchanged with a bucket or work platform.

Referring still to FIG. 19, the boom assembly 1840 includes an extension cylinder 1870. The extension cylinder 1870 is coupled at a first end with the base section 1850 and at a second end with the fly section 1854 or the middle section 1852. The extension cylinder 1870 can be a hydraulic cylinder or an electric cylinder. The hydraulic cylinder 1870 can receive pressurized hydraulic fluid and extend or retract to drive extension or retraction of the sections of the boom assembly 1840.

Referring still to FIG. 19, the boom assembly 1840 can also include a lift cylinder 1860. The lift cylinder 1860 is coupled with the base section 1850 at a first end and with a frame 1876 at a second end. The lift cylinder 1860 can extend or retract to drive rotation of the boom assembly 1840 in order to raise or lower the implement 270 (e.g., to drive the boom assembly 1840 about the axis 1872).

As shown in FIG. 19, the roto-handler 1800 includes a pair of stabilization systems 1830 (e.g., stabilizers, outriggers, an outrigger system, an extendable stabilizing member, a deployable stabilizer, etc.). The roto-handler 1800 includes a first stabilization system 1830 at a first end (e.g., a front) of the frame 1812 and a second stabilization system 1830 at a second end (e.g., a rear) of the frame 1812. The stabilization system 1830 includes a body 1832 (e.g., a frame, a receiving member, etc.), and a pair of arms 1834 that are received within the body 1832. The pair of arms 1834 are configured to telescope from the body 1832. The pair of arms 1834 include outrigger feet having a tubular member, shown as actuator receiver 1836 and a foot 1838. The foot 1838 can be provided on a rod that is received within the actuator receiver 1836.

The pair of arms 1834 are configured to actuate to extend or retract in a lateral direction along lateral axis 1842. In some embodiments, the arms 1834 extend from left and right openings of the body 1832. The arms 1834 can be operated to extend or retract outwards or inwards (e.g., to increase or decrease a distance between the feet 1838) using actuators similarly to the actuators 1016. The positions of the arms 1834 can be detected similarly to the actuators 1016 (e.g., using sensors 1026 or feedback from the actuators to determine length 1018 or length 1020) as described in greater detail above with reference to FIGS. 15-16.

The pair of arms 1834 can be extended to a desired position along the lateral axis 1842. The arms 1834 can include four arms that are independently operable. For example, the arms 1834 can include a front left arm, a front right arm, a rear left arm, and a rear right arm. Each of the arms 1834 can be operated by a user or operator of the roto-handler 1800 independently (e.g., by operating a corresponding actuator or cylinder). Once the arms 1834 are operated to their desired positions (e.g., a desired amount of extension for each of the front left, front right, rear left, and rear right arms), the user can operate the feet 1838 to deploy such that the feet 1838 engage or are driven into contact with a ground surface upon which the roto-handler 1800 rests. In some embodiments, the feet 1838 can be deployed to lift the tractive elements 1816 off the ground. The feet 1838 can be driven to extend (e.g., in a vertically downwards direction towards the ground surface) or retract (e.g., to move the feet 1838 out of engagement with the ground surface) by operation of an actuator within the actuator receiver 1836. The actuator can be a hydraulic cylinder or a linear electric actuator.

### Fire Apparatus

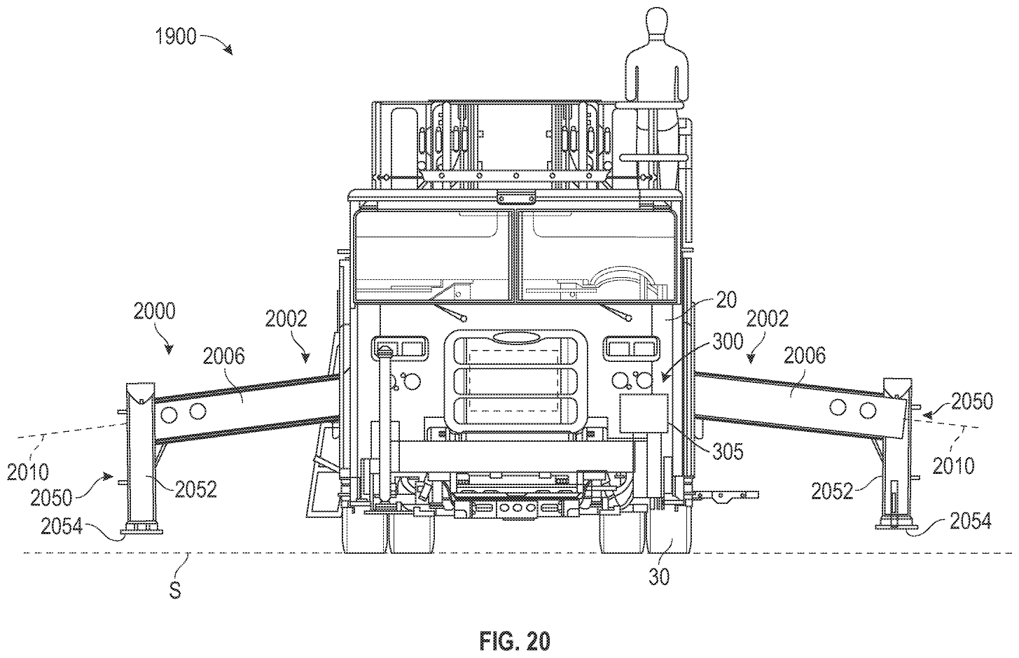

Referring to FIG. 20, a fire apparatus 1900 includes a pair of outriggers 2000 (e.g., an extendable stabilizing member). The fire apparatus 1900 includes tractive elements 30. The outriggers 2000 each include a first actuator assembly 2002 configured to extend in a primarily lateral direction. The first actuator assembly 2002 includes a first tubular member, shown as track, that is fixedly coupled to a torque box and the frame 12. The track receives a second tubular member, shown as telescoping section 2006, such that the telescoping section 2006 is slidably coupled to the track. A first linear actuator, shown as hydraulic cylinder 2008, is positioned within and coupled to the track and the telescoping section 2006. The hydraulic cylinder 2008 is powered by pressurized hydraulic fluid. In other embodiments, the hydraulic cylinder 2008 is a linear actuator powered by air (e.g., pneumatic, etc.), electrically (e.g., by an alternating current, by a direct current, etc.), mechanically (e.g., a flywheel, etc.), or still another power source. The hydraulic cylinder 2008 is configured to control extension and retraction of the telescoping section 2006. As the hydraulic cylinder 2008 extends, the telescoping section 2006 translates along an axis of extension 2010. The orientation of the axis of extension 2010 is defined by the orientation of the track.

Each outrigger 2000 further includes a second actuator assembly 2050 configured to extend in a substantially vertical direction. The second actuator assembly 2050 includes a third tubular member, shown as actuator receiver 2052. The actuator receiver 2052 is oriented substantially vertically and fixedly coupled to an end of the telescoping section 2006 opposite the frame 12. Accordingly, the second actuator assembly 2050 is indirectly coupled to the frame 12 and the torque box by the first actuator assembly 2002. The actuator receiver 2052 receives and is coupled to a second linear actuator (e.g., a hydraulic cylinder). The second linear actuator is coupled to a foot 2054. Accordingly, when the second linear actuator extends, the foot 2054 extends downward toward a support surface S (e.g., the ground surface) shown in FIG. 20. A ground pad extends directly between the foot 2054 and the support surface S. The ground pad has a larger surface area than the foot 2054. As the second linear actuator extends, the foot 2054 engages the ground pad, and the ground pad engages the support surface. The second linear actuator applies an upward force on the frame 12 through the first actuator assembly 2002. The ground pad spreads the force of the second linear actuator out over an area.

The fire apparatus 1900 can be a vehicle similar to the roto-handler 1800, the lift vehicle 100, the telehandler 200, etc. The stabilization systems 1830 of the roto-handler 1800 can be the same as or similar to the outriggers 2000. The outriggers 2000 are configured to extend laterally and vertically (e.g., in a downwards direction) to engage the ground surface S. The outriggers 2000 can be controlled by the control system 300 (e.g., the controller 305) similarly to the chassis axles 1006 as described in greater detail above with reference to FIGS. 10-18. In some embodiments, the stabilization system 1830 of the roto-handler 1800 or the outriggers 2000 are provided on the lift vehicle 100, or the telehandler 200.

The control system 300 and the controller 305 can be implemented for any vehicle (e.g., the fire apparatus 1900) including extendable axles as described in greater detail above with reference to FIGS. 10-16, or any vehicle having stabilizers or outriggers (e.g., the stabilization systems 1830 or the outriggers 2000). For example, the controller 305 can determine, based on a degree of extension of the outriggers 2000 or the stabilization systems 1830, a reach envelope (e.g., a reduced reach envelope) for the vehicle. In some embodiments, the controller 305 is configured to control a lift apparatus (e.g., the boom assembly 1840, the boom assembly 240, or the boom 140) similarly as described in greater detail above with reference to FIGS. 10-18, based on the footprint or degree of extension or retraction of the outriggers 2000 or the stabilization system 1830. It should be understood that the control system 300 can be provided on a lift apparatus including a boom, a telehandler, a roto-handler, a fire apparatus, a crane, etc., having extendable axles (e.g., as described in greater detail with reference to FIGS. 10-16) or stabilizers (e.g., outriggers) that are separate from the axles (e.g., as described in greater detail with reference to FIGS. 19-20).

### X-Chassis

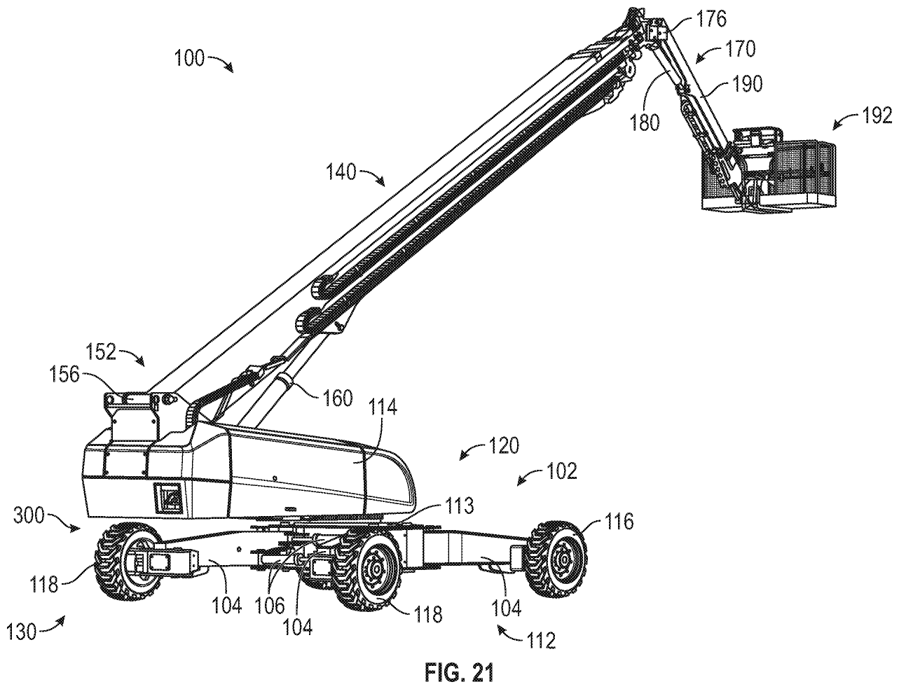

According to the exemplary embodiment shown in FIG. 21, the control system 300 can be implemented on an X-chassis configuration of the lift vehicle 100. The lift vehicle 100 includes the lift base or frame, shown as lift base 112. In other embodiments, the lift vehicle 100 is another type of vehicle (e.g., a fire apparatus, a military vehicle, an airport rescue fire fighting (“ARFF”) truck, a boom truck, a refuse vehicle, a fork lift, a crane, an excavator, an agricultural vehicle, etc.). The lift base 112 supports a rotatable structure, shown as turntable 114, and the boom assembly or telescoping boom, shown as boom 140. According to an exemplary embodiment, the turntable 114 is rotatable relative to the lift base 112. According to an exemplary embodiment, the turntable 114 includes a counterweight positioned at a rear of the turntable 114. In other embodiments, the counterweight is otherwise positioned and/or at least a portion of the weight thereof is otherwise distributed throughout the lift vehicle 100.

The first end, shown as front end 120, of the lift base 112 is supported by a first plurality of tractive elements, shown as front tractive elements 116, and an opposing second end, shown as rear end 130, of the lift base 112 is supported by a second plurality of tractive elements, shown as rear tractive elements 118. According to the exemplary embodiment shown in FIG. 21, the front tractive elements 116 and the rear tractive elements 118 include wheels. In other embodiments, the front tractive elements 116 and/or the rear tractive elements 118 include a track element.

As shown in FIG. 21, the boom 140 is coupled to the jib 170 at a distal end of the boom 140. By way of example, the boom 140 may include a plurality of telescoping boom sections that are configured to extend and retract along a longitudinal centerline thereof to selectively increase and decrease a length of the boom 140. In other embodiments, the boom 140 may include one or more sections that articulate with respect to one another (e.g., an articulating boom).

As shown in FIG. 21, the boom 140 has the first end (e.g., lower end, a proximal end, etc.), shown as the base end 152 that is pivotally coupled (e.g., pinned, etc.) to the turntable 114 at a joint, shown as lower boom pivot 156. The boom 140 includes the first actuator (e.g., pneumatic cylinder, electric actuator, hydraulic cylinder, etc.), shown as the lower lift cylinder 160. The lower lift cylinder 160 has the first end coupled to the turntable 114 and an opposing second end coupled to the lower boom 150. According to an exemplary embodiment, the lower lift cylinder 160 is positioned to raise and lower the boom 140 relative to the turntable 114 about the lower boom pivot 156.

As shown in FIG. 21, the boom 140 includes an implement, shown as platform assembly 192, coupled to the end of the jib 170 with the jib arm 190. As shown in FIG. 21, the boom 140 includes the second actuator (e.g., pneumatic cylinder, electric actuator, hydraulic cylinder, etc.), shown as upper lift cylinder 180. According to an exemplary embodiment, the upper lift cylinder 180 is positioned to actuate (e.g., lift, rotate, elevate, etc.) the jib 170 and the platform assembly 192 relative to the boom 140 about the pivot 176. In some embodiments, the platform assembly 192 may be removed and/or replaced with an implement or a robotic assembly.

According to an exemplary embodiment, the platform assembly 192 is a structure that is particularly configured to support one or more workers. In some embodiments, the platform assembly 192 includes an accessory or tool that may be accessed by a worker. Such tools may include pneumatic tools (e.g., impact wrench, airbrush, nail gun, ratchet, etc.), plasma cutters, welders, spotlights, etc. In some embodiments, the platform assembly 192 includes a control panel to control operation of the lift vehicle 100 (e.g., the turntable 114, the tractive elements 116/18, the boom 140, etc.) from the platform assembly 192. In other embodiments, the platform assembly 192 includes or is replaced with an accessory and/or tool (e.g., forklift forks, etc.).

According to an exemplary embodiment, the lift vehicle 100 includes the prime mover that is supported by and/or within the lift base 112. The prime mover provides power to the various components of the lift vehicle 100 (e.g., the lower lift cylinder 160, the upper lift cylinder 180, the tractive elements 116, 118, steering actuators/motors, etc.). In some embodiments, the prime mover is in the form of an internal combustion engine. In some embodiments, the prime mover is in the form of one or more electric motors powered by an energy storage system (e.g., a battery, a battery pack, a plurality of battery packs, etc.).

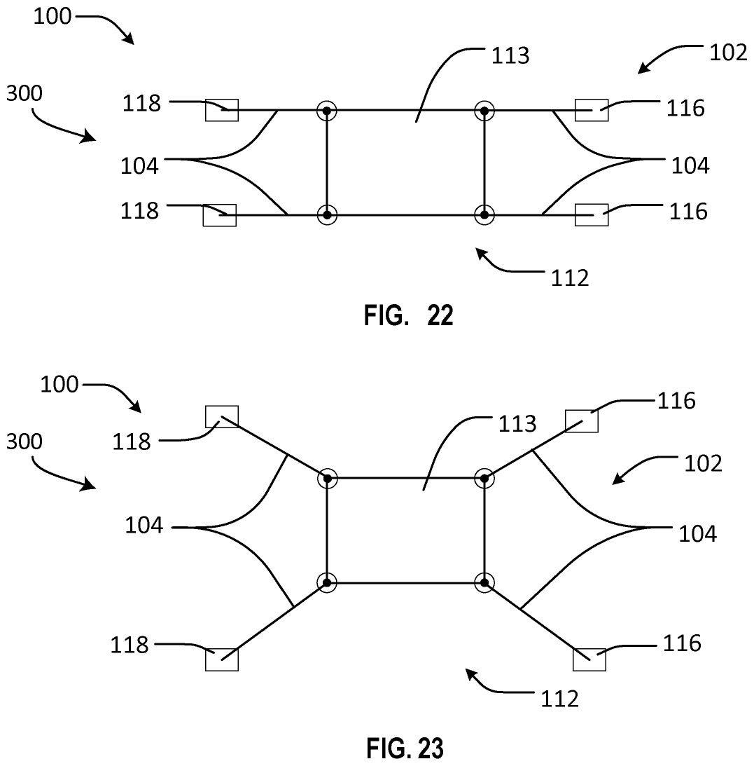

With continued reference to FIGS. 21-23, the lift base 112 of the lift vehicle 100 includes a center frame section 113 (e.g., the lift base 112) and the axle assembly 102 (e.g., the chassis axles 1006) that is coupled to and extends outwardly from the center frame section 113. According to an exemplary embodiment, the axle assembly 102 includes an axle arm 104 (e.g., an extendable or telescoping portion of the chassis axles 1006) coupled between each of the tractive elements 116/18 and the center frame section 113. Each of the axle arms 104 is pivotably or rotatably coupled to the center frame section 113 so that each of the axle arms 104 is expandable relative to the center frame section 113. For example, the axle assembly 102 may be movable between a retracted position (see, e.g., FIG. 22) where the axle arms 104 are retracted toward and/or under the center frame section 113, and an expanded position where the axle arms 104 are expanded outwardly from the center frame section 113 to define a generally X-shaped geometry. That is, the lift base 112 of the lift vehicle 100 defines a X-frame, variable geometry, or expandable chassis. In some embodiments, each of the axle arms 104 is coupled to an expanding actuator 106 that is coupled between the center frame section 113 and the corresponding axle arm 104. The expanding actuations 106 are configured to selectively move the axle arms 104 between the retracted position and the expanded position.

The control system 300 (e.g., the adaptive envelope techniques described herein with reference to FIGS. 1-20) can be implemented on the X-frame embodiment of the lift vehicle 100. For example, the axle arms 104 can be received within corresponding members that are coupled to the center frame section 113 and driven to extend or retract by actuators 1016. The control system 300 can be implemented on the X-frame embodiment of the lift vehicle 100 using corresponding techniques to adjust the reach envelope on one side or both sides based on the degree of extension or retraction of the axle arms 104. In some embodiments, the X-frame embodiment of the lift vehicle 100 includes outriggers 2000 separate from the axle arms 104. The control system 300 can adjust the envelope for either a first or second side of the lift vehicle 100 based on the distance 1060 between the right pair of front tractive elements 116 and rear tractive elements 118 and the center frame section 113 (e.g., a degree of extension or deployment of the axle arms 104 on the right side), and/or the distance 1060 on the left side of the lift vehicle 100. In some embodiments, the control system 300 is configured to adjust the envelope for either the first or second side of the lift vehicle 100 based on a degree of rotation of the lift arms 104, thereby indicating a degree of deployment.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system (e.g., coordinated lighting system, meshed beacon or road-flare system, virtual boundary system, etc.) as shown in the various exemplary embodiments is illustrative only. Additionally, any element disclosed in one embodiment may be incorporated or utilized with any other embodiment disclosed herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

What is claimed is:

1. A lift vehicle, comprising:
a chassis;
a lift apparatus configured to raise or lower an implement or platform;
a first extendable stabilizing member configured to extend and retract from a first side of the chassis;
a second extendable stabilizing member configured to extend and retract from a second side of the chassis; and
a controller configured to:
determine an amount of extension or retraction of the first extendable stabilizing member and the second extendable stabilizing member;
determine a reach envelope for both the first side and the second side of the chassis based on the amount of extension or retraction, the controller configured to decrease a size of the reach envelope with respect to reduced amounts of extension or retraction; and
in response to a user input to operate the lift apparatus, operate the lift apparatus according to the user input and restrict movement of the implement or platform beyond a boundary of the reach envelope.

2. The lift vehicle of claim 1, wherein the controller is configured to determine the reach envelope as a full capacity reach envelope in response to the first extendable stabilizing member and the second extendable stabilizing member being fully deployed.

3. The lift vehicle of claim 1, further comprising a first sensor configured to measure the amount of extension or retraction of the first extendable stabilizing member and a second sensor configured to measure the amount of extension or retraction of the second extendable stabilizing member, wherein the controller is configured to determine the amount of extension or retraction of the first extendable stabilizing member and the amount of extension or retraction of the second extendable stabilizing member based on sensor feedback from the first sensor and the second sensor.

4. The lift vehicle of claim 1, wherein the first extendable stabilizing member and the second extendable stabilizing member comprise tractive elements configured to engage a ground surface.

5. The lift vehicle of claim 1, wherein the first extendable stabilizing member and the second extendable stabilizing member are configured to extend or retract in unison in opposite directions from the chassis of the lift vehicle.

6. The lift vehicle of claim 1, wherein the reach envelope is configured to maintain a tipping moment of the lift vehicle less than a threshold amount at all positions of the implement or platform within the reach envelope.

7. The lift vehicle of claim 1, wherein the reach envelope is a predetermined envelope selected from a database based on the amount of extension or retraction of the first extendable stabilizing member and the second extendable stabilizing member.

8. The lift vehicle of claim 1, wherein the controller is configured to determine a footprint of the lift vehicle based on the amount of extension or retraction of the first extendable stabilizing member and the second extendable stabilizing member and determine the reach envelope based on the footprint.

9. The lift vehicle of claim 1, wherein the first extendable stabilizing member and the second extendable stabilizing member comprise outriggers separate from tractive elements of the lift vehicle.

10. A control system for a lift vehicle, the control system comprising:
a first extendable stabilizing member configured to extend and retract from a first side of the lift vehicle;
a second extendable stabilizing member configured to extend and retract from a second side of the lift vehicle; and
processing circuitry configured to:
determine an amount of extension or retraction of the first extendable stabilizing member and the second extendable stabilizing member;
determine a reach envelope for both the first side and the second side of the lift vehicle based on the amount of extension or retraction, the processing circuitry configured to decrease a size of the reach envelope with respect to reduced amounts of extension or retraction; and
in response to a user input to operate a lift apparatus of the lift vehicle, operate the lift apparatus according to the user input and restrict movement of an implement or platform beyond a boundary of the reach envelope.

11. The control system of claim 10, wherein the processing circuitry is configured to determine the reach envelope as a full capacity reach envelope in response to the first extendable stabilizing member and the second extendable stabilizing member being fully deployed.

12. The control system of claim 10, further comprising a first sensor configured to measure the amount of extension or retraction of the first extendable stabilizing member and a second sensor configured to measure the amount of extension or retraction of the second extendable stabilizing member, wherein the processing circuitry is configured to determine the amount of extension or retraction of the first extendable stabilizing member and the amount of extension or retraction of the second extendable stabilizing member based on sensor feedback from the first sensor and the second sensor.

13. The control system of claim 10, wherein the first extendable stabilizing member and the second extendable stabilizing member comprise tractive elements configured to engage a ground surface.

14. The control system of claim 10, wherein the first extendable stabilizing member and the second extendable stabilizing member are configured to extend or retract in unison in opposite directions from a chassis of the lift vehicle.

15. The control system of claim 10, wherein the reach envelope is configured to maintain a tipping moment of the lift vehicle less than a threshold amount at all positions of the implement or platform within the reach envelope.

16. The control system of claim 10, wherein the reach envelope is a predetermined envelope selected from a database based on the amount of extension or retraction of the first extendable stabilizing member and the second extendable stabilizing member.

17. The control system of claim 10, wherein the processing circuitry is configured to determine a footprint of the lift vehicle based on the amount of extension or retraction of the first extendable stabilizing member and the second extendable stabilizing member and determine the reach envelope based on the footprint.

18. The control system of claim 10, wherein the first extendable stabilizing member and the second extendable stabilizing member comprise outriggers separate from tractive elements of the lift vehicle.

19. A method of restricting operation of a lift device, the method comprising:
obtaining an indication of an amount of extension of a first extendable stabilizing member that protrudes from a first side of the lift device and extension of a second extendable stabilizing member that protrudes from a second side of the lift device;
determining a reach envelope for both the first side and the second side of the lift device based on the amount of extension or retraction, wherein a size of the reach envelope is decreased with respect to reduced amount of the extension or retraction; and
restricting movement of an implement or a platform of the lift device beyond the reach envelope.

20. The method of claim 19, comprising determining the reach envelope as a full capacity reach envelope in response to the first extendable stabilizing member and the second extendable stabilizing member being fully deployed.
